(19) United States
(12) Patent Application Publication
(10) Pub. No.: US 2024/0372174 A1
(43) Pub. Date: Nov. 7, 2024

(54) THERMAL MANAGEMENT SHEET, METHOD OF MANUFACTURE, AND ARTICLES USING THE SAME

(71) Applicant: ROGERS CORPORATION, Chandler, AZ (US)

(72) Inventors: An Le, Tolland, CT (US); Peyton Fleming, Southbury, CT (US); Joseph Puglisi, Ashford, CT (US); Max Kristy, Chicago, IL (US); Kenneth A. Mazich, Hinsdale, IL (US)

(73) Assignee: ROGERS CORPORATION, Chandler, AZ (US)

(21) Appl. No.: 18/648,719

(22) Filed: Apr. 29, 2024

Related U.S. Application Data
(60) Provisional application No. 63/463,639, filed on May 3, 2023.

(51) Int. Cl. H01M 10/658; C08G 18/48; C08G 18/76; C08J 9/00; C08J 9/30; C08K 3/38; H01M 50/211

(52) U.S. Cl. CPC H01M 10/658; C08G 18/48; C08G 18/7671; C08J 9/0066; C08J 9/30; H01M 50/211; C08J 2375/04; C08K 2003/387

(57) ABSTRACT

A method of forming a thermal management sheet for a battery including cured polyurethane foam, the method including combining an active hydrogen-containing component including a polyol and an isocyanate component including a polyisocyanate to form an uncured polyurethane foam; and curing the uncured polyurethane foam to form the cured polyurethane foam, wherein the uncured polyurethane foam includes, based on a total weight of the uncured polyurethane foam, 3 to 68 weight percent of sodium borate, 0.1 to 7 weight percent of surfactant, and 0.001 to 9 weight percent of catalyst, wherein the cured polyurethane foam has a density of 12 to 35 pounds per cubic foot, and wherein the cured polyurethane foam has a thickness of 1 to 30 millimeters.

### CROSS-REFERENCE TO RELATED APPLICATION

This application claims the benefit of U.S. Provisional Patent Application Ser. No. 63/463,639 filed May 3, 2023. The related application is incorporated herein in its entirety by reference.

### BACKGROUND

This application is directed to a thermal management sheet for use in batteries, particularly for delaying or preventing thermal runaway in lithium-ion batteries. The application is further directed to methods for the manufacture of the thermal management sheet and battery components and batteries including the thermal management sheet(s).

The demand for electrochemical energy storage devices, such as lithium-ion batteries, is ever increasing due to the growth of applications such as electric vehicles and grid energy storage systems, as well as other multi-cell battery applications, such as electric bikes, uninterrupted power battery systems, and replacements for lead acid batteries. Due to their increasing use, methods for heat management are desired. For large format applications, such as grid storage and electric vehicles, multiple electrochemical cells connected in series and parallel arrays are often used, which can lead to thermal runaway. Once a cell is in thermal runaway mode, the heat produced by the cell can induce a thermal runaway propagation reaction in adjacent cells, with the potential to cause a cascading effect that can ignite the entire battery.

While attempts to reduce thermal runaway in batteries have been considered, many have drawbacks. For example, modifying the electrolyte by adding flame retardant additives, or using inherently non-flammable electrolytes have been considered, but these approaches can negatively impact the electrochemical performance of the battery. Other approaches for heat management or to prevent cascading thermal runaway include incorporating an increased amount of insulation between cells or clusters of cells to reduce the amount of thermal heat transfer during a thermal event. However, these approaches can limit the upper bounds of the energy density that can be achieved.

With the increasing demand for batteries with improved heat management or reduced risk of thermal runaway, there is accordingly a need for methods and components for use in batteries that prevents or delays the spread of heat, energy, or both to surrounding cells.

### BRIEF SUMMARY

In an aspect, a method of forming a thermal management sheet for a battery comprising a cured polyurethane foam comprises combining an active hydrogen-containing component comprising a polyol and an isocyanate component comprising a polyisocyanate to form an uncured polyurethane foam; and curing the uncured polyurethane foam to form the cured polyurethane foam, wherein the uncured polyurethane foam comprises, based on a total weight of the uncured polyurethane foam, 3 to 68 weight percent (wt %), or 14 to 36 wt %, of sodium borate, 0.1 to 7 wt %, or 2 to 5 wt %, of surfactant, and 0.001 to 9 wt %, or 0.04 to 9 wt %, or 0.04 to 7 wt %, or 3 to 7 wt %, of catalyst, wherein the cured polyurethane foam has a density of 12 to 35 pounds per cubic foot (pcf) (192 to 561 kilograms per cubic meter (kg/m³)), or 15 to 20 pcf (240 to 320 kg/m³), and wherein the cured polyurethane foam has a thickness of 1 to 30 millimeters, or 1 to 20 millimeters, or 1 to 15 millimeters, or 1 to 10 millimeters, or 1 to 8 millimeters, or 1.5 to 8 millimeters, or 1.5 to 6 millimeters, or 2 to 4 millimeters.

An assembly for a battery includes the above-described thermal management sheet disposed on a surface of an electrochemical cell.

Batteries including the above-described assembly are also disclosed.

The above-described and other features are exemplified by the following figures, detailed description, examples, and claims.

### BRIEF DESCRIPTION OF THE DRAWINGS

The following is a brief description of the drawings, which are presented for the purpose of illustrating the exemplary embodiments disclosed herein and not for the purpose of limiting the same.

FIG. 1 is a schematic, cross-sectional illustration of an aspect of a thermal management sheet;

FIG. 2 is a schematic drawing of an aspect of a thermal management sheet located in between two cells;

FIG. 3 is a schematic drawing of an aspect of a thermal management sheet located in between two electrochemical cells;

FIG. 4 is a schematic drawing of an aspect of a thermal management sheet located in a cell array;

FIG. 5 is a schematic drawing of an aspect of an assembly for a battery including the thermal management sheet;

FIG. 6 is a schematic of an apparatus for a hot plate test;

FIG. 7 is a graph of temperature (° C.) versus time (minutes (min)) showing results of hot plate testing of Comparative Examples 1 and 2;

FIG. 8 is a graph of temperature (° C.) versus time (min) showing results of hot plate testing of Examples 1 and 2 and Comparative Examples 3-6;

FIG. 9 is a graph of temperature (° C.) versus time (min) showing results of hot plate testing of Examples 3-7;

FIG. 10 is a graph of hot plate temperature at 10 minutes (° C.) versus parts sodium borate showing results of hot plate testing of Examples 3-7;

FIG. 11 is a graph of temperature (° C.) versus time (min) showing results of hot plate testing of Comparative Examples 7 and 13-15;

FIG. 12 is a graph of temperature (° C.) versus time (min) showing results of hot plate testing of Comparative Examples 8-13;

FIG. 13 is a graph of temperature (° C.) versus time (min) showing results of hot plate testing of Comparative Examples 16 and 17;

FIG. 14 is a graph of temperature (° C.) versus time (min) showing results of hot plate testing of Comparative Examples 18-21;

FIG. 15 is a graph of temperature (° C.) versus time (min) showing results of hot plate testing of Examples 13 and 14 Comparative Examples 22-26;

FIG. 16 is a graph of temperature (° C.) versus time (min) showing results of hot plate testing of Examples 15-19;

FIG. 17 is a graph of temperature at 10 min (° C.) versus thickness (inches (in)) showing results of hot plate testing of Examples 11a-11i;

FIG. 18 is a graph of temperature at 10 min (° C.) versus density (pcf) showing results of hot plate testing of Examples 11a-11i;

FIG. 19 is a graph of temperature at 10 min (° C.) versus density (pcf) showing results of hot plate testing of Comparative Example 1a and Examples 9a, 10a, 10b, 10c, 11a, 11e, and 11h;

FIG. 20 is a graph of temperature at 10 min (° C.) versus parts sodium borate showing results of hot plate testing of Examples 9a, 10b, and 11a;

FIG. 21 is a graph of temperature at 10 min (° C.) versus sodium borate weight/square millimeters (mm²) showing results of hot plate testing of Comparative Example 1a and Examples 9a, 10a-10c, and 11a-11i;

FIG. 22A is an exploded view of schematic of an apparatus for nail penetration testing;

FIG. 22B is a non-exploded view of the schematic shown in FIG. 22A;

FIG. 23 is a graph of nail penetration delay (seconds (s)) versus parts sodium borate showing results of nail penetration testing of Examples 9a, 10b, and 11a;

FIG. 24 is a graph of nail penetration delay (seconds (s)) versus thickness (in) showing results of nail penetration testing of Examples 11a-11i; and

FIG. 25 is a graph of nail penetration delay (seconds (s)) versus density (pcf) showing results of nail penetration testing of Examples 11a-11i.

### DETAILED DESCRIPTION

Thermal management in batteries, for example, preventing thermal runaway in batteries, especially batteries that include a large plurality of electrochemical cells, is a difficult problem, as a cell adjacent to a cell experiencing a thermal runaway can absorb enough energy from the event to cause it to rise above its designed operating temperatures, triggering the adjacent cells to also enter into thermal runaway. This propagation of an initiated thermal runaway event can result in a chain reaction in which cells enter into a cascading series of thermal runaways, as the cells ignite adjacent cells. It has been particularly difficult to achieve effective thermal management properties in very thin sheets, for example, sheets that have a total thickness of 1 to 30 millimeters, or 1 to 20 millimeters, or 1 to 15 millimeters, or 1 to 10 millimeters, or 1 to 8 millimeters, or 1.5 to 8 millimeters, or 1.5 to 6 millimeters, or 2 to 4 millimeters. Thin sheets are increasingly desired to reduce article size and weight, and to conserve material.

The present inventors have found that a thermal management sheet that includes cured polyurethane foam and sodium borate in the disclosed amounts (e.g., 3 to 68 wt %, or 14 to 36 wt %, of sodium borate, based on a total weight of the uncured polyurethane foam) can be used to prevent or decrease the intensity of such cascading thermal runaway events. The present inventors have further found that certain components in the disclosed amounts provide for formation of cured polyurethane foam including sodium borate effective as a thermal management sheet. For example, cured polyurethane foam including sodium borate having a density of 12 to 35 pcf (192 to 561 kg/m³), or 15 to 20 pcf (240 to 320 kg/m³) can provide effective thermal management, and surfactant in the disclosed amount (e.g., 0.1 to 7 wt %, or 2 to 5 wt %, of surfactant, based on a total weight of the uncured polyurethane foam) provides appropriate frothing to provide a desired density. Further, catalyst in the disclosed amount (e.g., 0.001 to 9 wt %, or 0.04 to 9 wt %, or 0.04 to 7 wt %, or 3 to 7 wt %, of catalyst, based on a total weight of the uncured polyurethane foam) cures the uncured polyurethane foam including sodium borate to provide an effective thermal management sheet. An appropriate combination of factors such as sheet thickness, amount of sodium borate, and foam density can lead to effective thermal management.

A method of forming a thermal management sheet for a battery including a cured polyurethane foam includes combining an active hydrogen-containing component (also referred to herein as “Part A”) including a polyol and an isocyanate component (also referred to herein as “Part B”) including a polyisocyanate to form an uncured polyurethane foam; and curing the uncured polyurethane foam to form the cured polyurethane foam. In an aspect, the thermal management sheet consists essentially of, or consists of the cured polyurethane foam.

In an aspect, provided is an uncured polyurethane foam composition including a polyol; a polyisocyanate; 3 to 68 wt %, or 14 to 36 wt %, of sodium borate; 0.1 to 7 wt %, or 2 to 5 wt %, of surfactant; and 0.001 to 9 wt %, or 0.04 to 9 wt %, or 0.04 to 7 wt %, or 3 to 7 wt %, of catalyst, wherein weight percentages are based on a total weight of the uncured polyurethane foam composition. In an aspect, the uncured polyurethane foam composition includes a polyol; a polyisocyanate; 14 to 36 wt % of sodium borate; 2 to 5 wt % of surfactant; and 3 to 7 wt % of catalyst, wherein weight percentages are based on a total weight of the uncured polyurethane foam composition.

It has unexpectedly been found that use of sodium borate is especially useful in the manufacture of thermal management sheets including polyurethane foam. The thermal management sheet can be very thin and have good thermal insulation properties. The thermal management sheet can have additional advantageous properties, for example, good puncture resistance. The thermal management sheet can be subjected to multiple heating and cooling cycles, and still provide good thermal insulation. The thermal management sheet can further provide pressure management to the electrochemical cells and batteries. The thermal management sheet can be used in various sites in batteries to prevent thermal runaway. The thermal management sheet can further improve the flame resistance of batteries.

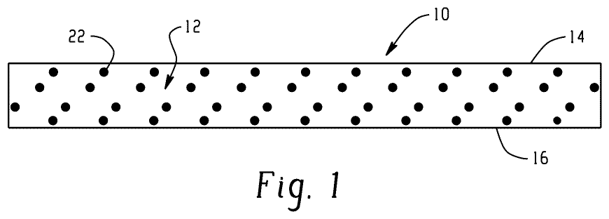

The thermal management sheet includes a flexible and porous layer and sodium borate. An aspect is shown in FIG. 1, where the thermal management sheet 10 includes a flexible polyurethane foam layer 12, e.g., cured polyurethane foam, having a first outer surface 14 and an opposite second outer surface 16. Although shown as flat, one or both or all of the outer surfaces can be contoured to provide better fit with a surface of an electrochemical cell.

Flexible polyurethane foam layer 12 further includes a plurality of openings, i.e., pores. The pores are defined by an inner surface of the flexible foam material. The pores can be interconnected or discrete. A combination of interconnected and discrete pores can be present. The pores can be wholly contained within the sheet, or at least a portion of the pores can be open to a surface of the sheet, allowing communication with the surrounding environment. In an aspect, at least a portion of the pores are interconnected and at least a portion of the pores are open, allowing passage of air, water, water vapor, or the like from first outer surface 14 to the opposite second outer surface 16, referred to herein as an “open-celled foam”. In an aspect, the foam can be a “closed cell foam”, where the pores may or may not interconnect, and are substantially not open to a surface of the sheet, or are completely closed, such that the sheet does not allow substantial passage of air, water, water vapor, or the like from one outer surface to the other outer surface. In an aspect, the foam is a substantially closed-cell foam, or a completely closed-cell foam.

With further reference to FIG. 1, the sodium borate 22 is distributed within the flexible polyurethane foam layer 12. The sodium borate can be distributed essentially uniformly, or as a gradient, for example, increasing from a first outer surface 14 in the direction of second outer surface 16. As used herein, the phrase “disposed within” can mean that the sodium borate is distributed within the matrix of the polyurethane foam layer as shown in FIG. 1. Further as used herein, the phrase “disposed within” can mean that the sodium borate can be located within a pore of the polyurethane foam layer, for example, coating an inner surface of the flexible foam material, or located within the pore. A portion of the number of pores in the polyurethane foam layer can contain the sodium borate, or essentially all, or all of the pores can contain the sodium borate. Each pore containing the sodium borate can independently be partially filled, essentially fully filled, or fully filled.

The polyurethane foam is selected to be inert to the ordinary operating conditions of a battery such as a lithium-ion battery and to act as a carrier for the sodium borate, as described in more detail herein. Various polyurethane foams can be used.

Without wishing to be bound by any theory, it is understood that upon exposure to heat, the sodium borate can produce or generate water, which can mitigate heat transfer to an adjoining cell. As used herein “generating water” can refer to release of water, for example, from a hydrate, or formation of water, e.g., by a chemical reaction process. Furthermore, the water generated can be in the form of a liquid or water vapor. As used herein “water” accordingly includes liquid water, water vapor, or a combination thereof. “Heat” as used herein means heat above the ordinary operating temperature of the battery, and includes heat produced by a flame or contact with a flame. Such temperatures can be 100° C. or higher, or 200° C. or higher, or 300° C. or higher, or 500° C. or higher. Without being bound by theory, it is believed that generating water from the sodium borate can provide thermal barrier properties by absorbing heat, redistributing heat, or by vaporization of water.

The sodium borate can be incorporated into the polyurethane foam during manufacture thereof. As described herein, the sodium borate can be located within the polyurethane matrix of the polyurethane foam layer, within a pore of the polyurethane foam layer, or both. A portion of the number of pores in the polyurethane foam layer can contain sodium borate, or essentially all, or all of the pores can contain sodium borate. Each pore containing the sodium borate can independently be partially filled, essentially fully filled, or fully filled. In an aspect in which particles of the sodium borate are large relative to a diameter of the pore, or the pore is essentially or fully filled with a plurality of smaller particles of sodium borate, movement of the sodium borate within the pore can be restricted. The sodium borate can be located in the pores during manufacture of the layer (for example, by including the sodium borate in the composition used to form the polyurethane foam layer), or the sodium borate can be impregnated into the pores after manufacture of the polyurethane foam layer using a suitable liquid carrier, vacuum, or other suitable method.

A combination of different placements can be used. For example, sodium borate within a pore of the polyurethane foam layer can be used in combination with sodium borate distributed within the polyurethane foam layer.

In an aspect, most, essentially all, or all, of the particles of sodium borate have a largest dimension less than the thickness of the layer or the pore in which they are located, to provide a smooth surface to the layer. The particular diameters used therefore depend on the location of the sodium borate particles. Bi-, tri-, or higher multimodal distributions of sodium borate particles can be used. For example, when sodium borate is present within the matrix of the polyurethane foam layer and within the pores of the polyurethane foam layer, a bimodal distribution of sodium borate particles can be present.

Sodium borate included in the polyurethane foam can produce water upon exposure to a heat source. The water can expand the polyurethane foam to provide a counterpressure. Without being bound by theory, generating water can absorb the heat to prevent thermal runaway. Further heat can be absorbed by conversion of liquid water to water vapor. The heat capacity of the sodium borate can further contribute to heat absorption.

Other fillers such as aluminum trihydroxide (ATH) and zinc borate, alone or in combination with each other, or alone or in combination with sodium borate, may not perform as well as sodium borate alone in a polyurethane foam. In an aspect, the uncured polyurethane foam includes, based on the total weight of the uncured polyurethane foam, 0 wt % aluminum trihydrate. In an aspect, the uncured polyurethane foam includes, based on the total weight of the uncured polyurethane foam, 0 wt % zinc borate. In an aspect, the uncured polyurethane foam includes, based on the total weight of the uncured polyurethane foam, 0 wt % aluminum trihydrate and 0 wt % zinc borate.

ATH and zinc borate, alone or in combination with each other, may be included in combination with sodium borate, and provide desirable results. In an aspect, the uncured polyurethane foam can further include, based on the total weight of the uncured polyurethane foam, 0 to 33 wt %, or greater than 0 to 33 wt %, or 7 to 18 wt % of aluminum trihydrate. In an aspect, the uncured polyurethane foam can further include, based on the total weight of the uncured polyurethane foam, 0 to 33 wt %, or greater than 0 to 33 wt %, or 7 to 18 wt % of zinc borate. In an aspect, the uncured polyurethane foam can further include, based on the total weight of the uncured polyurethane foam, 0 to 33 wt %, or greater than 0 to 33 wt %, or 6 to 18 wt %, of aluminum trihydrate, and 0 to 33 wt %, or greater than 0 to 33 wt %, or 6 to 18 wt %, zinc borate.

Sodium borate is available from manufacturers such as SAE Manufacturing Specialties Corp., Surepure Chemetals, Inc., Mil-Spec Industries, Noah Chemicals, ProChem, Inc., Rose Mill Co., U.S. Borax, Quality Borate, and BariteWorld. Zinc borate is available from manufacturers such as SAE Manufacturing Specialties Corp., Surepure Chemetals, Inc., Mil-Spec Industries, Noah Chemicals, ProChem, Inc., Rose Mill Co., U.S. Borax, Quality Borate, and BariteWorld. ATH is available from manufacturers such as SAE Manufacturing Specialties Corp., Surepure Chemetals, Inc., Mil-Spec Industries, USALCO, LLC, Cimbar Perfromance Metals, Huber Engineered Materials, LKAB Minerals, MarkeTech International, R.J. Marshall Company, Aluchem, and Alcan Chemicals.

The thermal management sheet can be manufactured from polyurethane foam-forming compositions. The sodium borate can be incorporated into the polyurethane foam-forming composition before the polyurethane is foamed and cured.

The polyurethane foams can be formed from a reactive composition comprising an organic isocyanate-containing component reactive with an active hydrogen-containing composition, a surfactant, a catalyst, and the above filler components. Each of the organic isocyanate component and the active hydrogen-containing component can include one or more different types of each type of compound.

The organic polyisocyanate component used in the preparation of polyurethane foams comprises at least a polyisocyanate having the general formula Q(NCO)ᵢ, wherein i is an integer having an average value of two or greater, and Q is an organic radical having a valence of i. Q can be a substituted or unsubstituted group (for example, an alkane or an aromatic group of the appropriate valency). Q can be a group having the formula Q¹-Z-Q¹ wherein Q¹ is an alkylene or arylene group and Z is —O—, O-Q¹-S—, —CO—, —S—, —S-Q¹-S—, —SO—, or —SO₂—. Q can represent a polyurethane radical having a valence of i.

Examples of suitable polyisocyanates include hexamethylene diisocyanate, 1,8-diisocyanato-p-methane, xylyl diisocyanate, diisocyanatocyclohexane, phenylene diisocyanates, tolylene diisocyanates, including 2,4-tolylene diisocyanate, 2,6-tolylene diisocyanate, and crude tolylene diisocyanate, bis(4-isocyanatophenyl)methane, chlorophenylene diisocyanates, diphenylmethane-4,4′-diisocyanate (also known as 4,4′-diphenyl methane diisocyanate, or MDI) and adducts thereof, naphthalene-1,5-diisocyanate, triphenylmethane-4,4′,4″-triisocyanate, isopropylbenzene-alpha-4-diisocyanate, or polymeric isocyanates such as polymethylene polyphenylisocyanate.

The active hydrogen-containing component includes at least one multi-functional active hydrogen containing compound, which can be a polyamine or a polyol, for example a polyether polyol, a polyester polyol, a lower molecular weight polyol, or a combination thereof. Suitable polyester polyols are inclusive of polycondensation products of polyols with dicarboxylic acids or ester-forming derivatives thereof (such as anhydrides, esters and halides), polylactone polyols obtainable by ring-opening polymerization of lactones in the presence of polyols, polycarbonate polyols obtainable by reaction of carbonate diesters with polyols, or castor oil polyols. Suitable dicarboxylic acids and derivatives of dicarboxylic acids that are useful for producing polycondensation polyester polyols are aliphatic or cycloaliphatic dicarboxylic acids such as glutaric, adipic, sebacic, fumaric or maleic acids; dimeric acids; aromatic dicarboxylic acids such as phthalic, isophthalic or terephthalic acids; tribasic or higher functional polycarboxylic acids such as pyromellitic acid; as well as anhydrides or second alkyl esters, such as maleic anhydride, phthalic anhydride or dimethyl terephthalate. The polymers of cyclic esters can also be used. The preparation of cyclic ester polymers from at least one cyclic ester monomer is exemplified by U.S. Pat. No. 3,021,309 through U.S. Pat. Nos. 3,021,317; 3,169,945; and 2,962,524. Suitable cyclic ester monomers include but are not limited to δ-valerolactone; ϵ-caprolactone; zeta-enantholactone; the monoalkyl-valerolactones, e.g., the monomethyl-, monoethyl-, and monohexyl-valerolactones. In general the polyester polyol may comprise a caprolactone-based polyester polyol, an aromatic polyester polyol, an ethylene glycol adipate-based polyol, or a combination thereof. Polyester polyols made from ϵ-caprolactones, adipic acid, phthalic anhydride, and terephthalic acid or dimethyl esters of terephthalic acid are generally preferred.

Polyether polyols can be obtained by the chemical addition of alkylene oxides, such as ethylene oxide, propylene oxide, or a combination thereof, to water or polyhydric organic components, such as ethylene glycol, propylene glycol, trimethylene glycol, 1,2-butylene glycol, 1,3-butanediol, 1,4-butanediol, 1,5-pentanediol, 1,2-hexylene glycol, 1,10-decanediol, 1,2-cyclohexanediol, 2-butene-1,4-diol, 3-cyclohexene-1,1-dimethanol, 4-methyl-3-cyclohexene-1,1-dimethanol, 3-methylene-1,5-pentanediol, diethylene glycol, (2-hydroxyethoxy)-1-propanol, 4-(2-hydroxyethoxy)-1-butanol, 5-(2-hydroxypropoxy)-1-pentanol, 1-(2-hydroxymethoxy)-2-hexanol, 1-(2-hydroxypropoxy)-2-octanol, 3-allyloxy-1,5-pentanediol, 2-allyloxymethyl-2-methyl-1,3-propanediol, [4,4-pentyloxy)-methyl]-1,3-propanediol, 3-(o-propenylphenoxy)-1,2-propanediol, 2,2′-diisopropylidenebis(p-phenyleneoxy)diethanol, glycerol, 1,2,6-hexanetriol, 1,1,1-trimethylolethane, 1,1,1-trimethylolpropane, 3-(2-hydroxyethoxy)-1,2-propanediol, 3-(2-hydroxypropoxy)-1,2-propanediol, 2,4-dimethyl-2-(2-hydroxyethoxy)-methylpentanediol-1,5; 1,1,1-tris[2-hydroxyethoxy)methyl]-ethane, 1,1,1-tris[2-hydroxypropoxy)-methyl]propane, diethylene glycol, dipropylene glycol, pentaerythritol, sorbitol, sucrose, lactose, alpha-methylglucoside, alpha-hydroxyalkylglucoside, a novolac polymer, phosphoric acid, benzenephosphoric acid, a polyphosphoric acid such as tripolyphosphoric acid and tetrapolyphosphoric acid, ternary condensation products, and the like. The alkylene oxides used in producing polyoxyalkylene polyols can have 2 to 4 carbon atoms, or 2 to 3 carbon atoms. Exemplary alkylene oxides are propylene oxide and mixtures of propylene oxide with ethylene oxide. Polytetramethylene polyether diol or glycol, and mixture with one or more other polyols, can be specifically mentioned. The polyols listed above can be used per se as the active hydrogen component.

A specific class of polyether polyols is represented generally by the formula R[(OCₙH₂ₙ)_{z}OH]ₐ wherein R is hydrogen or a polyvalent hydrocarbon radical; a is an integer (i.e., 2 to 8) equal to the valence of R, n in each occurrence is an integer from 2 to 4 inclusive (preferably 3) and z in each occurrence is an integer having a value of 2 to 200, preferably 15 to 100. Specifically, the polyether polyol can have the formula R[(OC₄H₈)_{z}OH]₂, wherein R is a divalent hydrocarbon radical and z in each occurrence is 2 to about 40, specifically 5 to 25.

Another type of active hydrogen-containing material that can be used is a polymer polyol composition obtained by polymerizing ethylenically unsaturated monomers with a polyol as described in U.S. Pat. No. 3,383,351, the disclosure of which is incorporated herein by reference. Suitable monomers for producing such compositions include acrylonitrile, vinyl chloride, styrene, butadiene, vinylidene chloride, and other ethylenically unsaturated monomers as identified and described in the above-mentioned U.S. Patent. Suitable polyols include those listed and described above and in U.S. Pat. No. 3,383,351. The active hydrogen-containing component may also contain polyhydroxy-containing compounds such as hydroxyl-terminated polyhydrocarbons (U.S. Pat. No. 2,877,212); hydroxyl-terminated polyformals (U.S. Pat. No. 2,870,097); fatty acid triglycerides (U.S. Pat. Nos. 2,833,730 and 2,878,601); hydroxyl-terminated polyesters (U.S. Pat. Nos. 2,698,838, 2,921,915, 2,591,884, 2,866,762, 2,850,476, 2,602,783, 2,729,618, 2,779,689, 2,811,493, 2,621,166 and 3,169,945); hydroxymethyl-terminated perfluoromethylenes (U.S. Pat. Nos. 2,911,390 and 2,902,473); hydroxyl-terminated polyalkylene ether glycols (U.S. Pat. No. 2,808,391; British Patent No. 733,624); hydroxyl-terminated polyalkylenearylene ether glycols (U.S. Pat. No. 2,808,391); and hydroxyl-terminated polyalkylene ether triols (U.S. Pat. No. 2,866,774).

The active-hydrogen-containing component, in particular the polyol component, can further include a very low molecular weight chain extender, cross-linking agent, or combination thereof. Exemplary chain extenders and cross-linking agents include alkane diols, dialkylene glycols and/or polyhydric alcohols, preferably triols and tetrols, having a molecular weight from about 200 to 400 Dalton. The chain extenders and cross-linking agents can be used, for example in an amount of 0.5 to 20 percent by weight, or 10 to 15 percent by weight, based on the total weight of the active-hydrogen-containing component. Other chain extenders can be a very low molecular weight (below about 200 Dalton) diol, including but not being limited to, dipropylene glycol, 1,4-butanediol, 2-methyl-1,3-propanediol, and 3-methyl-1,5-pentane diol.

In an embodiment, the active hydrogen-containing component is a polyol component that comprises a higher molecular weight polyether polyol, for example a polyether polyol having a weight average molecular weight (Mw) of 500 to about 4,000, or 1,000 and 3,000, and a hydroxy number of 10 to 200; a polyester polyol, such as a polycaprolactone-based polyol, or a combination thereof, and a very low molecular weight polyol as a chain extender or crosslinking agent. Exemplary polyether polyols include polyoxyalkylene diols and triols, and polyoxyalkylene diols and triols with polystyrene and/or polyacrylonitrile grafted onto the polymer chain, or a combination thereof. A triol can be present, such as a polycaprolactone triol having an Mw of 50 to 3,000 and a hydroxy number can be 200 to 2,000, preferably 500 to 1500. A preferred triol is a polycaprolactone triol.

In general, the average weight percent hydroxy, based on the hydroxyl numbers of the hydroxyl-containing compounds (including all polyols or diols), including other cross-linking additives, fillers, surfactants, catalysts, and pigments, if used, can be 500 to 400, depending on the desired firmness or softness of the polyurethane. The hydroxyl number is defined as the number of milligrams of potassium hydroxide required for the complete neutralization of the hydrolysis product of the fully acetylated derivative prepared from 1 gram of polyol or polyol component with or without other cross-linking additives.

A number of catalysts can be used to catalyze the reaction of the isocyanate component with the active hydrogen-containing component. The amount of catalyst in the uncured polyurethane foam is 0.001 to 9 wt %, or 0.04 to 9 wt %, or 0.04 to 7 wt %, or 3 to 7 wt %, of catalyst, based on a total weight of the uncured polyurethane foam. Such catalysts include organic and inorganic acid salts of, or organometallic derivatives of bismuth, lead, tin, iron, antimony, uranium, cadmium, cobalt, thorium, aluminum, mercury, zinc, nickel, cerium, molybdenum, vanadium, copper, manganese, or zirconium, as well as phosphines or tertiary organic amines of these metals. Examples of such catalysts are dibutyltin dilaurate, dibutyltin diacetate, stannous octoate, lead octoate, cobalt naphthenate, bis(2,4-pentanedionate) nickel (II) or derivatives thereof such as diacetonitrilediacetylacetonato nickel, diphenylnitrilediacetylacetonato nickel, or bis(triphenylphosphine)diacetyl acetylacetonato nickel. The catalyst can comprise ferric acetylacetonate, triethylamine, triethylenediamine, N,N,N′,N′-tetramethylethylenediamine, 1,1,3,3-tetramethylguanidine, N,N,N′N′-tetramethyl-1,3-butanediamine, N,N-dimethylethanolamine, N,N-diethylethanolamine, 1,3,5-tris (N,N-dimethylaminopropyl)-s-hexahydrotriazine, o- and p-(dimethylaminomethyl) phenols, 2,4,6-tris(dimethylaminomethyl) phenol, N,N-dimethylcyclohexylamine, pentamethyldiethylenetriamine, 1,4-diazobicyclo [2.2.2] octane, N-hydroxyl-alkyl quaternary ammonium carboxylates and tetramethylammonium formate, tetramethylammonium acetate, or tetramethylammonium 2-ethylhexanoate. A catalyst delay agent can optionally be present, for example as is described in U.S. Pat. Nos. 10,023,681, 9,228,047 and 5,733,945. A combination of at least two different catalysts can be used.

The reactive composition can comprise a surfactant that can stabilize the reactive composition before it is cured. The surfactant can comprise an organosilicone surfactant. The organosilicone can comprise a copolymer comprising or consisting essentially of SiO₂ (silicate) units and (CH₃)₃SiO_{0.5} (trimethylsiloxy) units in a molar ratio of silicate to trimethylsiloxy units of 0.8:1 to 2.2:1, or 1:1 to 2.0:1. The organosilicone can comprise a partially cross-linked siloxane-polyoxyalkylene block copolymer, wherein the siloxane blocks and polyoxyalkylene blocks are linked by silicon to carbon, or by silicon to oxygen to carbon. The surfactant can be present in an amount of 0.5 to 10 wt %, or 1 to 6 wt %, based on the total weight of the active hydrogen component. The surfactant is present in an amount of 0.1 to 7 wt %, or 2 to 5 wt %, based on a total weight of the uncured polyurethane foam.

Other, optional additives can be added to the reactive composition. For example, the additive can comprise a filler (for example, alumina trihydrate, silica, talc, calcium carbonate, or clay), desiccant, dyes, pigments (for example, titanium dioxide or iron oxide), antioxidants, antiozonants, UV stabilizers, conductive fillers, or conductive polymers.

Methods for the manufacture of foams are generally known. The foams can be mechanically frothed, physically or chemically blown, or both. The polyurethane foams can be made by casting a mechanically frothed composition. In particular, the reactive precursors of the polyurethane can be mixed and mechanically, frothed, then cast to form a layer, and cured.

Physical blowing agents can be used alone or as mixtures with each other or with one or more chemical blowing agents. Physical blowing agents can be selected from a broad range of materials, including hydrocarbons, ethers, esters and partially halogenated hydrocarbons, ethers, and esters, and the like. Typical physical blowing agents have a boiling point of −50 to 100° C., or −50 to 50° C. Exemplary physical blowing agents include CFC's (chlorofluorocarbons) (for example, 1,1-dichloro-1-fluoroethane, 1,1-dichloro-2,2,2-trifluoro-ethane, monochlorodifluoromethane, or 1-chloro-1,1-difluoroethane); FC's (fluorocarbons) (for example, 1,1,1,3,3,3-hexafluoropropane, 2,2,4,4-tetrafluorobutane, 1,1,1,3,3,3-hexafluoro-2-methylpropane, 1,1,1,3,3-pentafluoropropane, 1,1,1,2,2-pentafluoropropane, 1,1,1,2,3-pentafluoropropane, 1,1,2,3,3-pentafluoropropane, 1,1,2,2,3-pentafluoropropane, 1,1,1,3,3,4-hexafluorobutane, 1,1,1,3,3-pentafluorobutane, 1,1,1,4,4,4-hexafluorobutane, 1,1,1,4,4-pentafluorobutane, 1,1,2,2,3,3-hexafluoropropane, 1,1,1,2,3,3-hexafluoropropane, 1,1-difluoroethane, 1,1,1,2-tetrafluoroethane, or pentafluoroethane); FE's (fluoroethers) (for example, methyl-1,1,1-trifluoroethylether or difluoromethyl-1,1,1-trifluoroethylether); or hydrocarbons (for example, n-pentane, isopentane, or cyclopentane). The physical blowing agent can comprise at least one of carbon dioxide, ethane, propane, n-butane, isobutane, pentane, hexane, butadiene, acetone, methylene chloride, any of the chlorofluorocarbons, hydrochlorofluorocarbons, or hydrofluorocarbons. As with the chemical blowing agents, the physical blowing agents can be used in an amount sufficient to give the resultant foam the desired bulk density. Typically, physical blowing agents are used in an amount of 5 to 50 wt %, or 10 to 30 wt %, based on the total weight of the reactive composition.

If a chemical blowing agent is used, it can comprise at least one of water, an azo compound (for example, azoisobutyronitrile, azodicarbonamide (i.e. azo-bis-formamide), or barium azodicarboxylate); a substituted hydrazine (for example, diphenylsulfone-3,3′-disulfohydrazide, 4,4′-hydroxy-bis-(benzenesulfohydrazide), trihydrazinotriazine, or aryl-bis-(sulfohydrazide)); a semicarbazide (for example, p-tolylene sulfonyl semicarbazide, or 4,4′-hydroxy-bis-(benzenesulfonyl semicarbazide)); a triazole (for example, 5-morpholyl-1,2,3,4-thiatriazole); an N-nitroso compound (for example, N,N′-dinitrosopentamethylene tetramine or N,N-dimethyl-N,N′-dinitrosophthalmide); benzoxazine (for example, isatoic anhydride); or a mixture (for example, a sodium carbonate/citric acid mixture). The chemical blowing agent can comprise water. The blowing agent can comprise at least one of an ammonium salt, a phosphate, a polyphosphate, a borate, a polyborate, a sulphate, a urea, a urea-formaldehyde resin, a dicyandiamide, or a melamine.

The amount of the foregoing chemical blowing agents will vary depending on the agent and the desired foam density, and is readily determinable by one of ordinary skill in the art. In general, these chemical blowing agents are used in an amount of 0.1 to 10 wt %, based on the total weight of the reactive composition. The decomposition products formed during the decomposition process can be physiologically safe, and that may not significantly adversely affect the thermal stability or mechanical properties of the foamed polyurethane sheets.

In an aspect, the polyurethane foam is produced by mechanically mixing the reactive composition (including the isocyanate component, the active hydrogen-containing component, a froth-stabilizing surfactant, the catalyst, and other optional additives) with a froth-forming gas. The frothed mixture can be fed onto a release liner and spread to a layer of desired thickness by a doctoring blade or other suitable spreading device. The gauged layer of the frothed mixture can then be delivered to one or more heating zones. After the heating zone, the formed polyurethane layer can be passed to a cooling zone.

For example, in the production of polyurethane foams, the reactive components of the polyurethane foam-forming composition can be formulated in two parts, one part (“Part A”) containing the active hydrogen-containing component and the sodium borate, the catalyst, the surfactant, and if used the inhibitor, and a chemical blowing agent; and the other part (“Part B”) containing the organic isocyanate component. The parts can be metered, mixed, and cast, for example, into a mold or a continuous coating line. The foaming and curing then occurs either in the mold or on the continuous coating line. In a method of production, the reactive components of the polyurethane foam-forming composition can be introduced into an extruder together with the sodium borate and a chemical blowing agent, a physical blowing agent, or other additives if used. The catalyst can then be metered into the extruder to start the foaming and curing reaction. The use of physical blowing agents such as liquid carbon dioxide or supercritical carbon dioxide in conjunction with chemical blowing agents such as water can give rise to foam having much lower densities.

In an aspect, 70 to 90 wt %, or 75 to 89 wt %, of the active hydrogen-containing component (“Part A”) and 10 to 30 wt %, or 11 to 25 wt %, of the isocyanate component (“Part B”) can be combined to form the uncured polyurethane foam. In an aspect, sodium borate can also be added to the Part B.

Optionally, the thermal management sheet can be immersed in water for a period of time, for example, 24 hours, to imbibe water into the thermal management sheet. The high heat capacity of liquid water can contribute to significantly delaying heat transfer from one surface of the thermal management sheet to the other surface of the thermal management sheet.

The amount of the sodium borate can provide a desired degree of thermal barrier properties. The uncured polyurethane foam can include 3 to 68 wt %, or 14 to 36 wt %, of the sodium borate, based on the total weight of the uncured polyurethane foam.

During oven curing, some of the bound water of the sodium borate can be released by the heat of the oven. This additional water can increase the effective formula OH, and additional isocyanate moieties can assist with curing of the foam. A stoichiometry ratio of isocyanate moieties to active hydrogen-containing groups, e.g., hydroxyl groups, in the uncured polyurethane foam of 0.85:1 to 1.40:1, or 1.00:1 to 1.20:1, can be used, as opposed to the stoichiometrically calculated ratio of isocyanate moieties to active hydrogen-containing groups, e.g., hydroxyl groups, in the uncured polyurethane foam of 1:1.

The polyurethane foam-forming composition can be foamed and cured in the presence of reinforcing fibers to provide fibrous reinforcement. The reinforcing fibers can include polyester, oxidized polyacrylonitrile, carbon, silica, polyaramid, polycarbonate, polyolefin, rayon, nylon, fiberglass (e.g., E glass, S glass, D glass, L glass, quartz fibers, or a combination thereof), high density polyolefin, ceramics, acrylics, fluoropolymer, polyurethane, polyamide, polyimide, or the like, or a combination thereof. The reinforcing fibers can be in any suitable form, such as a woven or nonwoven mat or tape. The mat or tape can have a thickness of, for example, 0.005 to 10 millimeters (mm), or 0.05 to 8 mm, or 0.25 to 6 mm, or 0.5 to 10 mm, or 0.25 to 10 mm, or 0.5 to 10 mm, or 1 to 10, or 1 mm to 6 mm. A combination of a reinforcing particulate material and reinforcing fibers can be used.

The thermal management sheet can have a void volume content of 5 to 99%, for example, greater than or equal to 30%, based upon the total volume of the foam.

The thermal management sheet is flexible, and can maintain its elastic behavior over many cycles on compression deflection over the life of the battery, properties reflected by compressive force deflection and compression set of the foam. Foams with good compression set resistance provide cushioning, and maintain their original shape or thickness under loads for extended periods. In an aspect, the thermal management sheet, e.g., the cured polyurethane foam, has a compression force deflection of 0.2 to 125 pounds per square inch (psi) (1 to 862 kilopascals (kPa)), or 0.25 to 20 psi (1.7 to 138 kPa), or 0.5 to 10 psi (3.4 to 68.90.5 kPa), each at 25% deflection and determined in accordance with ASTM D3574-17. The thermal management sheet, e.g., the cured polyurethane foam, can have a compression set of 0 to 15%, or 0 to 10%, or 0 to 5%, or greater than 0 to 15%, or greater than 0 to 10%, or greater than 0 to 5%, determined in accordance with ASTM D 3574-95 Test D at 70° C.

In an aspect, the thermal management sheet is used as a single layer. Multiple single layers can be stacked, however, and used as a single layer. Other layers can be used in combination with the thermal management sheet, for example, a flame retardant layer, a nonporous elastomeric barrier layer, an adhesive layer, or the like, or a combination thereof. However, one advantage of the thermal management sheet is that a single sheet used alone can be effective without other layers even at thicknesses as low as 1 to 30 mm, or 1 to 20 mm, or 1 to 15 mm, or 1 to 10 mm, or 1 to 8 mm, or 1 to 6 mm.

If used, the flame retardant layer can include a flame retardant inorganic material such as boehmite, aluminum hydroxide, magnesium hydroxide, an intumescent material, or a combination thereof. The intumescent material can include an acid source, a blowing agent, and a carbon source. Each component can be present in separate layers or as an admixture, for example, an intimate admixture. For example, the intumescent material can include an acid source, a blowing agent, and a carbon source. For example, as the temperature reaches a value, for example, of 200 to 280° C., the acidic species (for example, of the polyphosphate acid) can react with the carbon source (for example, pentaerythritol) to form a char. As the temperature increases, for example, to 280 to 350° C., the blowing agent can then decompose to yield gaseous products that cause the char to swell.

The acid source can include, for example, an organic or an inorganic phosphorous compound, an organic or inorganic sulfate (for example, ammonium sulfate), or a combination thereof. The organic or inorganic phosphorous compound can include an organophosphate or organophosphonate (for example, tris(2,3-dibromopropyl)phosphate, tris(2-chloroethyl)phosphate, tris(2,3-dichloropropyl)phosphate, tris(1-chloro-3-bromoisopropyl) phosphate, bis(1-chloro-3-bromoisopropyl)-1-chloro-3-bromoisopropyl phosphonate, polyaminotriazine phosphate, melamine phosphate, triphenyl phosphate, or guanylurea phosphate); an organophosphite ester (for example, trimethyl phosphite, or triphenyl phosphite); a phosphazene (for example, hexaphenoxycyclotriphosphazene); a phosphorus-containing inorganic compound (for example, phosphoric acid, phosphorus acid, a phosphite, urea phosphate, an ammonium phosphate (for example, ammonium monohydrogen phosphate, ammonium dihydrogen phosphate, or ammonium polyphosphate)); or a combination thereof.

The blowing agent can include an agent that decomposes (for example, into smaller compounds such as ammonia or carbon dioxide) at a temperature of greater than or equal to 120° C., for example, at 120 to 200° C., or at 130 to 200° C. The blowing agent can include a dicyandiamide, an azodicarbonamide, a melamine, a guanidine, a glycine, a urea (for example, a urea-formaldehyde resin or a methylolated guanylurea phosphate), a halogenated organic material (for example, a chlorinated paraffin), or a combination thereof.

The intumescent material can include a carbon source. The polyurethane foam layer can function as the carbon source. The carbon source can include dextrin, a phenol-formaldehyde resin, pentaerythritol (for example, a dimer or trimer thereof), a clay, a polymer (for example, polyamide 6, an amino-poly(imidazoline-amid), or polyurethane), or a combination thereof. The amino-poly(imidazoline-amid) can include repeating amide linkages and imidazoline groups.

The intumescent material can optionally further include a binder. The binder can include an epoxy, a polysulfide, a polysiloxane, a polysilarylene, or a combination thereof. The binder can be present in the intumescent material in an amount of less than or equal to 50 wt %, or 5 to 50 wt %, or 35 to 45 wt %, based on the total weight of the intumescent material. The binder can be present in the intumescent material in an amount of 5 to 95 wt %, or 40 to 60 wt %, based on the total weight of the intumescent material.

The intumescent material can optionally include a synergistic compound to further improve the flame retardance of the intumescent material. The synergistic compound can include a boron compound (e.g., zinc borate, boron phosphate, or boron oxide), a silicon compound, an aluminosilicate, a metal oxide (e.g., magnesium oxide, ferric oxide, or aluminum oxide hydrate (boehmite)), a metal salt (e.g., alkali metal or alkaline earth metal salts of organosulfonic acids or alkaline earth metal carbonates), or a combination thereof. Synergistic combinations can include phosphorus-containing compounds with at least one of the foregoing.

The flame retardant layer can further include a char-forming agent, for example, a lignin, boehmite, clay nanocomposite, expandable graphite, pentaerythritol, cellulose, nanosilica, ammonium polyphosphate, lignosulfonate, melamine, cyanurate, zinc borate, huntite, hydromagnesite, or a combination thereof. Without being bound by theory, similar to the intumescent material, it is believed that the char-forming agent can reduce the spread of flames using two energy absorbing mechanisms, including forming a char and then swelling the char.

The flame retardant layer can further include a polymer binder, for example, a silicone, a polyurethane, an ethylene-vinyl acetate, an ethylene-methyl acrylate, an ethylene-butyl acrylate, or a combination thereof. The flame retardant layer can have a thickness of 0.1 to 2 mm, 0.5 to 1.5 mm, or 0.8 to 1.1 mm.

If used, the nonporous elastomeric barrier layer includes an elastomer having a permeability coefficient for water of less than 20 g-mm per m² per day, or less than 10 g-mm per m² per day, or less than 5 g-mm per m² per day, each measured at 25° C. and 1 atmosphere; or a tensile stress at 100% elongation of 0.5 to 15 megaPascals measured at 21° C. in accordance with ASTM 412; or a combination thereof. The nonporous elastomeric barrier layer can have a thickness of 0.25 to 1 mm or 0.4 to 0.8 mm.

The nonporous elastomeric barrier layer can include an elastomeric material that is hydrophobic, to prevent water or water vapor transmission. For example, the elastomeric barrier layer can include a thermoplastic elastomer (TPE), provided that it has a desirable hydrophobicity (lack of water or water vapor transmission). Classes of TPEs include styrenic block copolymers (TPS or TPE-s), (TPO or TPE-o), thermoplastic vulcanizates (TPV or TPE-v), thermoplastic polyurethane, thermoplastic copolyesters (TPC or TPE-E), thermoplastic polyamides (TPA or TPE-A), and others.

Examples of elastomeric materials that can be used include an acrylic rubber, butyl rubber, halogenated butyl rubber, copolyester, epichlorohydrin rubber, ethylene-acrylic rubber, ethylene-butyl acrylic rubber, ethylene-diene rubber (EPR) such as ethylene-propylene rubber, ethylene-propylene-diene monomer rubber (EPDM), ethylene-vinyl acetate, fluoroelastomer, perfluoroelastomer, polyamide, polybutadiene, polychloroprene, polyolefin rubber, polyisoprene, polysulfide rubber, natural rubber, nitrile rubber, low density polyethylene, polypropylene, thermoplastic polyurethane elastomer (TPU), silicone rubber, fluorinated silicone rubber, styrene-butadiene, styrene-isoprene, vinyl rubber, or a combination thereof. In an aspect the nonporous elastomeric barrier layer includes ethylene-propylene-diene monomer rubber, polychloroprene, or a combination thereof.

An adhesive layer can be present to adhere a thermal management sheet to another thermal management sheet, another type of layer, or to a component of the cell array or batter. A wide variety of suitable adhesives can be used in the thermal management sheet. The adhesive can be selected for ease of application and stability under the operating conditions of the battery. Each adhesive layer can the same or different, and be of the same or different thickness. Suitable adhesives include a phenolic resin, an epoxy adhesive, a polyester adhesive, a polyvinyl fluoride adhesive, an acrylic or methacrylic adhesive, or a silicone adhesive, preferably an acrylic adhesive or a silicone adhesive. In an aspect, the adhesive is a silicone adhesive. Solvent-cast, hot-melt, and two-part adhesives can be used. Each of the adhesive layers can independently have a thickness of 0.00025 to 0.010 inches (0.006 to 0.25 mm), or 0.0005 to 0.003 inches (0.01 to 0.08 mm).

When the thermal management sheet includes an adhesive layer, the thermal management sheet can further include a release layer. By “release layer” is meant any single or layer including a release coating, optionally supported by one or more additional layers including a release liner. The thickness of each of the release layers can be 5 to 150 micrometers (μm), 10 to 125 μm, 20 to 100 μm, 40 to 85 μm, or 50 to 75 μm.

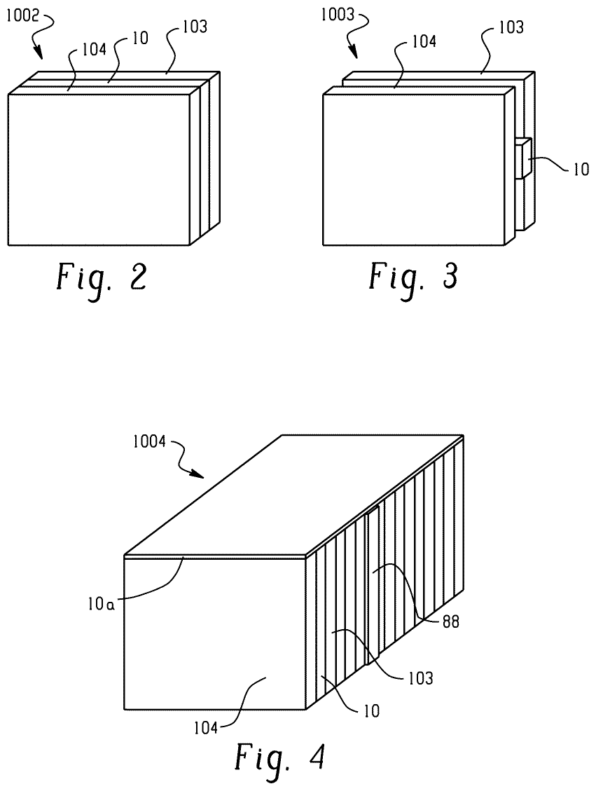

The thermal management sheet is disposed on an electrochemical cell to provide a cell assembly for a battery. The cells can be lithium-ion cells, in particular, prismatic, cylindrical, or pouch cells. FIG. 2 illustrates an aspect of the positioning of the thermal management sheet in a cell assembly 1002 and FIG. 3 illustrates an aspect of the positioning of the thermal management sheet in a cell assembly 1003. FIG. 2 and FIG. 3 illustrate that the thermal management sheet 10 can be located between a first cell 103 and a second cell 104. FIG. 2 illustrates that the thermal management sheet 10 can be approximately the same size as the height and width of the cells 103, 104. FIG. 3 illustrates that the thermal management sheet 10 can be smaller than the respective cells 103, 104. Also as shown in FIG. 3 it is also possible for the thermal management sheet 10 to extend past an edge of an electrochemical cell 103, 104. A thermal management sheet extending past an edge of an electrochemical cell can wrap around and cover at least another portion or all of another surface of the cell.

FIG. 4 illustrates that multi-cell assembly 1004 can include more than two cells 103, 104 with thermal management sheet 10 located in between the respective cells 103, 104. The cells can be lithium-ion cells, in particular pouch cells. FIG. 4 illustrates that an assembly 1004 for a battery can include more than two cells (e.g., 103, 104) with thermal management sheet 10 located in between the respective cells 103, 104 and each of the other cells. In an aspect, two to ten thermal management sheets can be disposed on a cell or in a cell array during manufacture of the assembly 1004 for a battery. For example, two to ten thermal management sheets can be disposed on the interior, e.g., facing the electrodes, or exterior, facing outside of the battery. Two to ten thermal management sheets can be disposed on or adhered to a cell or pouch of a pouch cell, or both. Of course, one or more than ten of the thermal management sheets can be present depending on the number of cells and cell arrays. FIG. 4 further illustrates thermal management sheet 10a disposed on an exterior of assembly 1004 for a battery, to face outside of a battery.

In an aspect, at least a portion of an exposed outer edge of the thermal management sheet can include a material 88 that pulls heat away from the body of the thermal management sheet. Exemplary materials to apply to an exposed edge of the thermal management sheet include ceramics such as boron nitride or aluminum nitride, a metal such as aluminum, a high heat capacity wax, a phase change material, or the like, or a combination thereof.

The cell assemblies are used in batteries. A battery includes a housing that at least partially encloses one or more electrochemical cells or cell arrays. The housing can be of any suitable type, for example, a polymer or a pouch of a pouch cell. The thermal management sheet can be disposed on, or disposed directly on a cell or cell array in any suitable configuration in the battery. The thermal management sheet can be placed between individual cells or cell arrays in the battery. The thermal management sheet can be placed on, e.g., at the top, in between, below, adjacent, or a combination thereof the sides of the cells or cell arrays in the battery, a portion thereof, or a selected set of cells or cell arrays in the battery. The thermal management sheet can be placed or adhered to a plurality of pouch cells, pressure management pads, cooling plates, or other interior battery components. The assembly pressure of the battery can hold stacked components into place.

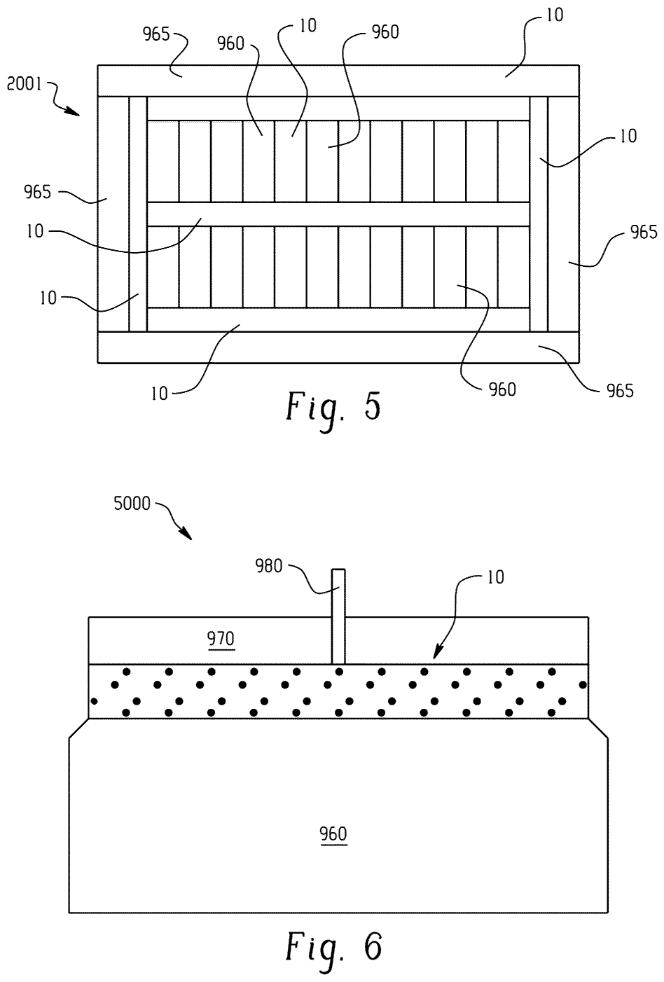

For example, as shown in FIG. 5, a battery 2001 can contain a plurality of cells in a plurality of cell arrays 960 inside a housing 965. The thermal management sheet 10 can be disposed between two cell arrays 960. Further as shown in FIG. 5, the thermal management sheet 10 can be disposed between a side of housing 965 and a side of a cell array 960, along a plurality of the cells of the cell array. Also as shown in FIG. 5, the thermally insulating thermal management sheet 10 can be disposed between an end of housing 965 and an end of one or more cell arrays 960.

If more than one thermal management sheet or other layer is used, the sheets and layers can be assembled by suitable methods. The sheets and layers can be assembled on a surface of a cell or other component of a battery (for example, a wall of a battery case). In an aspect, the sheets and layers are assembled separately, and then placed or adhered to the cell, the battery component, or both. Each of the sheets or layers can be manufactured separately, and then stacked (placed or adhered using, for example, one or more adhesive layers) in the desired order. Alternatively, one or more individual layers can be manufactured on another individual layer, for example, by coating, casting, or laminating using heat and pressure. For example, in an aspect, a flame retardant layer or an adhesive layer can be directly cast onto the thermal management sheet or the thermal management sheet can also be directly cast onto the flame retardant layer. Direct coating or casting can decrease thickness and improve flame retardance by eliminating an adhesive layer.

The following examples are provided to illustrate the present disclosure. The examples are merely illustrative and are not intended to limit devices made in accordance with the disclosure to the materials, conditions, or process parameters set forth therein.

### EXAMPLES

The materials listed in Table 1 were used in the examples.

TABLE 1

| Component | Description |
|---|---|
| FR | Phosphorus-containing, halogen-free flame retardant |
| Carbon black | Carbon black dispersed in polymer polyol |
| Sodium borate | Filler, hydrate; Na₂B₄O₇•5H₂O, sodium tetraborate pentahydrate, borax 5 mol; CAS: 12179-04-3 |
| Zinc borate | Filler, hydrate; 2ZnO•3B₂O₃•3.5H₂O; CAS: 138265-88-00 |
| ATH | Filler, hydrate; 2Al(OH)₃, aluminum trihydrate, 25 micron particle size; CAS: 21645-51-2 |
| APB | Filler, hydrate; Ammonium pentaborate tetrahydrate, 99%, (NH₄)B₅O₈•4H₂O, CAS: 12046-04-7 |
| CaSO₄•2H₂O | Filler; calcium sulfate dihydrate, CAS: 10101-41-4 |
| CaC₂O₄•H₂O | Filler; calcium oxalate monohydrate, CAS: 5794-28-5 |
| Exp. Graphite | Filler, intumescent; expandable graphite |
| MC-APP | Filler, phosphorus-based flame retardant; melamine-coated ammonium polyphosphate powder, |
| | (NH₄PO₃)ₙ where n > 1000, 15 micron particle size, CAS 68333-79-9 |
| SC-APP | Filler, phosphorus-based flame retardant; silane-coated ammonium polyphosphate powder, |
| | (NH₄PO₃)ₙ where n > 1000, 12 micron particle size, CAS 68333-79-9 |
| Sodium Silicate | Filler, silicon source; Na₂SO•H₂O, CAS: 1344-09-8, SiO₂/Na₂O = 3.22 |
| Silica | Filler, silicon source; Natural, fine ground silica, D 50 = 1.6 micron |
| Lignin | Filler, char forming; lignosulfonic acid, sodium salt, MW = 52,000, CAS: 8061-51-6 |
| Aerogel | Filler, aerogel powder, 2-40 micron particle size, 20 nanometer pore diameter, CAS 102262-30- |
| | 6 |
| PCM | Filler, phase change material MPCM 43D; micro-encapsulated paraffin blend phase change |
| | material, 43° C. melting point, 15-30 micron particle size |
| Surfactant | Silicone surfactant with hydrolyzable stability |
| Desiccant | 3 Å Molecular sieve powder (alkali metal alumino-silicate), <10 micron particle size, |
| | K₁₂[(AlO₂)₁₂(SiO₂)₁₂]•XH₂O |
| Antioxidant | Butylated hydroxytoluene (BHT) |
| Polyol | Polyol blend including polyether polyol blend and optional polyester polyol, chain extender |
| | (active hydrogen-containing component) |
| Isocyanate | Methylene diphenyl diisocyanate (MDI)-based prepolymer, NCO content = 30-33 wt % |
| Catalyst | Catalyst for reaction of isocyanate and active hydrogen-containing component |

### Sample Preparation

Samples were made by preparing a two-part formulation having a Part A (including polyol) as shown in Tables 2 to 7 and a Part B (including isocyanate (ISO)). In Tables 2 to 7, and “Isocyanate” is the molar ratio of isocyanate moieties to hydroxyl groups.

Examples 1-7 and Comparative Examples 3-21 were made by preparing 100 to 300 gram batches of Part A and frothing Part A. The appropriate amount of Part B was added, and the mixture was further frothed. The frothed mixture was then poured onto a release layer on a casting line. The frothed mixture was spread to a layer of desired thickness by a doctoring blade and cured. The amounts shown in Tables 2 to 7 are parts by weight.

For Examples 8-19, 9a, 10a-10c, and 11a-11i and Comparative Examples 22-26 and 1a, 16 to 32 kilogram batches of Part A were prepared. Part A and Part B were both pumped to a mix head at appropriate ratios, and were frothed together before being dispensed through a nozzle onto a casting line. Air could be injected into the mix head, and the density could be better controlled compared to Examples 1-7 and Comparative Examples 3-21. Comparative Examples 1-2 are production samples, which are produced in a similar manner to Examples 8-14 and Comparative Examples 22-26 except at larger scale.

TABLE 2A

| | Ex1 | Ex2 | Ex3 | Ex4 | Ex5 | Ex6 | Ex7 |
|---|---|---|---|---|---|---|---|
| FR | 4.00 | 4.00 | 4.00 | 4.38 | 5.00 | 5.63 | 5.94 |
| Carbon Black | 2.00 | 2.00 | 2.00 | 2.19 | 2.50 | 2.81 | 2.97 |
| Sodium Borate | 36.00 | 18.00 | 36.00 | 30.00 | 20.00 | 10.00 | 5.00 |
| Zinc Borate | | 18.00 | | | | | |
| ATH | | | | | | | |
| Catalyst | 7.00 | 7.00 | 7.00 | 7.66 | 8.75 | 9.85 | 10.39 |
| Surfactant | 4.87 | 4.87 | 4.87 | 5.33 | 6.09 | 6.85 | 7.23 |
| Desiccant | 2.03 | 2.03 | 2.03 | 2.22 | 2.54 | 2.86 | 3.02 |
| Antioxidant | 0.06 | 0.06 | 0.06 | 0.06 | 0.07 | 0.08 | 0.08 |
| Polyol | 44.04 | 44.04 | 44.04 | 48.15 | 55.06 | 61.92 | 65.37 |
| Total Parts | 100.00 | 100.00 | 100.00 | 99.99 | 100.01 | 100.00 | 100.00 |
| Isocyanate | 1.04 | 1.04 | 1.04 | 1.04 | 1.04 | 1.04 | 1.04 |
| Density (pcf) | 32.5 | 38.5 | 37.6 | 46.0 | 45.4 | 49.1 | 49.2 |
| Thickness (in) | 0.177 | 0.168 | 0.076 | 0.061 | 0.069 | 0.062 | 0.061 |

TABLE 2B

| | Ex8 | Ex9 | Ex10 | Ex11 | Ex12 | Ex13 | Ex14 |
|---|---|---|---|---|---|---|---|
| Sodium Borate | 5.00 | 10.00 | 20.00 | 36.00 | 40.00 | 18.00 | 18.00 |
| Zinc Borate | | | | | | | 18.00 |
| ATH | | | | | | 18.00 | |
| Catalyst | 7.00 | 7.00 | 7.00 | 7.00 | 7.00 | 7.00 | 7.00 |
| Surfactant | 4.80 | 4.80 | 4.80 | 4.80 | 4.80 | 4.80 | 4.80 |
| Desiccant | 5.00 | 5.00 | 5.00 | 5.00 | 5.00 | 5.00 | 5.00 |
| Antioxidant | 0.06 | 0.06 | 0.06 | 0.06 | 0.06 | 0.06 | 0.06 |
| Polyol | 78.14 | 73.14 | 63.14 | 47.14 | 43.14 | 47.14 | 47.14 |
| Total Parts | 100.00 | 100.00 | 100.00 | 100.00 | 100.00 | 100.00 | 100.00 |
| Isocyanate | 1.15 | 1.15 | 1.15 | 1.15 | 1.15 | 1.15 | 1.15 |
| Density (pcf) | 18.7 | 19.2 | 20 | 20.7 | 20.7 | 20.2 | 19.2 |
| Thickness (in) | 0.079 | 0.074 | 0.075 | 0.08 | 0.083 | 0.081 | 0.083 |

TABLE 3

| | CE1 | CE2 | CE3 | CE4 | CE5 | CE6 | CE7 | CE8 | CE9 | CE10 | CE11 |
|---|---|---|---|---|---|---|---|---|---|---|---|
| FR | | | 4.00 | 4.00 | 4.00 | 4.00 | 4.00 | 4.00 | 4.00 | 4.00 | 4.00 |
| Carbon Black | 6.30 | 6.30 | 2.00 | 2.00 | 2.00 | 2.00 | 2.00 | 2.00 | 2.00 | 2.00 | 2.00 |
| Sodium Borate | | | | | | | | 26.00 | 10.00 | 18.00 | 18.00 |
| Zinc Borate | | | | 36.00 | 18.00 | | | | | | |
| ATH | 10.00 | 4.00 | 36.00 | | 18.00 | | | | | | |
| APB | | | | | | 36.00 | | | | | |
| Exp. Graphite | | 20.00 | | | | | | | | 18.00 | |
| MC-APP | | | | | | | | | | | 18.00 |
| Sodium Silicate | | | | | | | | 10.00 | | | |
| Silica | | | | | | | | | 26.00 | | |
| Lignin | | | | | | | 36.00 | | | | |
| Catalyst | 5.00 | 5.00 | 7.00 | 7.00 | 7.00 | 7.00 | 7.00 | 7.00 | 7.00 | 7.00 | 7.00 |
| Surfactant | 5.00 | 5.00 | 4.87 | 4.87 | 4.87 | 4.87 | 4.87 | 4.87 | 4.87 | 4.87 | 4.87 |
| Desiccant | 2.00 | 2.00 | 2.03 | 2.03 | 2.03 | 2.03 | 2.03 | 2.03 | 2.03 | 2.03 | 2.03 |
| Antioxidant | 0.08 | 0.08 | 0.06 | 0.06 | 0.06 | 0.06 | 0.06 | 0.06 | 0.06 | 0.06 | 0.06 |
| Polyol | 70.58 | 70.08 | 44.04 | 44.04 | 44.04 | 44.04 | 44.04 | 44.04 | 44.04 | 44.04 | 44.04 |
| Total Parts | 98.96 | 112.46 | 100.00 | 100.00 | 100.00 | 100.00 | 100.00 | 100.00 | 100.00 | 100.00 | 100.00 |
| Isocyanate | 1.04 | 1.04 | 1.04 | 1.04 | 1.04 | 1.04 | 1.04 | 1.04 | 1.04 | 1.04 | 1.04 |
| Density (pcf) | 10.0 | 10.0 | 51.4 | 47.9 | 53.2 | 19.5 | 15.5 | 31.8 | 52.4 | 46.7 | 49.9 |
| Thickness (in) | 0.157 | 0.126 | 0.15 | 0.171 | 0.15 | 0.141 | 0.148 | 0.087 | 0.061 | 0.069 | 0.068 |

TABLE 4

| | CE12 | CE13 | CE14 | CE15 | CE16 |
|---|---|---|---|---|---|
| FR | 4.00 | 4.00 | 4.00 | 4.00 | 5.31 |
| Carbon Black | 2.00 | 2.00 | 2.00 | 2.00 | 2.66 |
| Sodium Borate | 18.00 | 18.00 | | | |
| Zinc Borate | | | 18.00 | | |
| MC-APP | | | | 18.00 | 18.00 |
| SC-APP | 18.00 | | | | |
| Lignin | | 18.00 | 18.00 | 18.00 | |
| Catalyst | 7.00 | 7.00 | 7.00 | 7.00 | 7.00 |
| Surfactant | 4.87 | 4.87 | 4.87 | 4.87 | 6.47 |
| Desiccant | 2.03 | 2.03 | 2.03 | 2.03 | 2.03 |
| Antioxidant | 0.06 | 0.06 | 0.06 | 0.06 | 0.08 |
| Polyol | 44.04 | 44.04 | 44.04 | 44.04 | 58.45 |
| Total Parts | 100.00 | 100.00 | 100.00 | 100.00 | 100.00 |
| Isocyanate | 1.04 | 1.04 | 1.04 | 1.04 | 1.04 |
| Density (pcf) | 51.3 | 26.7 | 20.8 | 22.9 | 55.7 |
| Thickness (in) | 0.065 | 0.103 | 0.157 | 0.139 | 0.058 |

TABLE 5

| | CE17 | CE18 | CE19 | CE20 | CE21 | CE22 | CE23 | CE24 | CE25 | CE27 |
|---|---|---|---|---|---|---|---|---|---|---|
| FR | 5.31 | 5.82 | | | | | | | | |
| Carbon Black | 2.66 | 2.91 | | | | | | | | |
| Sodium Borate | | 10.00 | | | | | | | | 18.00 |
| Zinc Borate | | | | | | | 36.00 | 18.00 | | |
| ATH | | | | | | | | 18.00 | 36.00 | |
| CaSO₄•2H₂O | | | 36.00 | | | | | | | |
| CaC₂O₄•H₂O | | | | 36.00 | | | | | | |
| Exp. Graphite | | | | | | | | | | 18.00 |
| SC-APP | 18.00 | | | | | | | | | |
| MC-APP | | | | | | 36.00 | | | | |
| Aerogel | | 2.00 | | | | | | | | |
| PCM | | | | | 36.00 | | | | | |
| Catalyst | 7.00 | 7.00 | 7.00 | 7.00 | 7.00 | 7.00 | 7.00 | 7.00 | 7.00 | 7.00 |
| Surfactant | 6.47 | 7.09 | 4.80 | 4.80 | 4.80 | 4.80 | 4.80 | 4.80 | 4.80 | 4.80 |
| Desiccant | 2.03 | 2.00 | 5.00 | 5.00 | 5.00 | 5.00 | 5.00 | 5.00 | 5.00 | 5.00 |
| Antioxidant | 0.08 | 0.08 | 0.06 | 0.06 | 0.06 | 0.06 | 0.06 | 0.06 | 0.06 | 0.06 |
| Polyol | 58.45 | 64.1 | 47.14 | 47.14 | 47.14 | 47.14 | 47.14 | 47.14 | 47.14 | 47.14 |
| Total Parts | 100.00 | 101.00 | 100.00 | 100.00 | 100.00 | 100.00 | 100.00 | 100.00 | 100.00 | 100.00 |
| Isocyanate | 1.04 | 1.4 | 1.1 | 1.1 | 1.1 | 1.15 | 1.15 | 1.15 | 1.15 | 1.15 |
| Density (pcf) | 52.0 | 29.8 | 52.0 | 63.4 | 37.2 | 19.5 | 20.2 | 20 | 19.2 | 18.8 |
| Thickness (in) | 0.071 | 0.152 | 0.122 | 0.058 | 0.069 | 0.087 | 0.087 | 0.081 | 0.079 | 0.078 |

TABLE 6

| | Ex15 | Ex16 | Ex17 | Ex18 | Ex19 |
|---|---|---|---|---|---|
| Sodium Borate | 5.00 | 10.00 | 20.00 | 36.00 | 40.00 |
| Catalyst | 7.00 | 7.00 | 7.00 | 7.00 | 7.00 |
| Surfactant | 4.80 | 4.80 | 4.80 | 4.80 | 4.80 |
| Desiccant | 5.00 | 5.00 | 5.00 | 5.00 | 5.00 |
| Antioxidant | 0.06 | 0.06 | 0.06 | 0.06 | 0.06 |
| Polyol | 78.14 | 73.14 | 63.14 | 47.14 | 43.14 |
| Total Parts | 100.00 | 100.00 | 100.00 | 100.00 | 100.00 |
| Isocyanate | 1.15 | 1.15 | 1.15 | 1.15 | 1.15 |
| Density (pcf) | 18.7 | 19.2 | 20 | 20.7 | 20.7 |
| Thickness (in) | 0.079 | 0.074 | 0.075 | 0.08 | 0.083 |

TABLE 7

| | CEla | Ex9a | Ex10a | Ex10b | Ex10c | Ex11a | Ex11b | Ex11c | Ex11d | Ex11e | Ex11f | Ex11g | Ex11h | Ex11i |
|---|---|---|---|---|---|---|---|---|---|---|---|---|---|---|
| Carbon black | 6.30 | | | | | | | | | | | | | |
| Sodium borate | | 10.00 | 20.00 | 20.00 | 20.00 | 36.00 | 36.00 | 36.00 | 36.00 | 36.00 | 36.00 | 36.00 | 36.00 | 36.00 |
| ATH | 10.00 | | | | | | | | | | | | | |
| Catalyst | 5.00 | 7.00 | 7.00 | 7.00 | 7.00 | 7.00 | 7.00 | 7.00 | 7.00 | 7.00 | 7.00 | 7.00 | 7.00 | 7.00 |
| Surfactant | 5.00 | 4.80 | 4.80 | 4.80 | 4.80 | 4.80 | 4.80 | 4.80 | 4.80 | 4.80 | 4.80 | 4.80 | 4.80 | 4.80 |
| Desiccant | 2.00 | 5.00 | 5.00 | 5.00 | 5.00 | 5.00 | 5.00 | 5.00 | 5.00 | 5.00 | 5.00 | 5.00 | 5.00 | 5.00 |
| Antioxidant | 0.08 | 0.06 | 0.06 | 0.06 | 0.06 | 0.06 | 0.06 | 0.06 | 0.06 | 0.06 | 0.06 | 0.06 | 0.06 | 0.06 |
| Polyol | 70.58 | 73.14 | 63.14 | 63.14 | 63.14 | 47.14 | 47.14 | 47.14 | 47.14 | 47.14 | 47.14 | 47.14 | 47.14 | 47.14 |
| Total Parts | 98.96 | 100.00 | 100.00 | 100.00 | 100.00 | 100.00 | 100.00 | 100.00 | 100.00 | 100.00 | 100.00 | 100.00 | 100.00 | 100.00 |
| Isocyanate | 1.04 | 1.15 | 1.15 | 1.15 | 1.15 | 1.15 | 1.15 | 1.15 | 1.15 | 1.15 | 1.15 | 1.15 | 1.15 | 1.15 |
| Density (pcf) | 11.3 | 20.6 | 33.2 | 20.9 | 15.2 | 20.1 | 20 | 20.2 | 15.2 | 14.8 | 14.8 | 30 | 29.5 | 28.8 |
| Thickness (in) | 0.116 | 0.127 | 0.111 | 0.124 | 0.122 | 0.11 | 0.154 | 0.078 | 0.081 | 0.118 | 0.151 | 0.084 | 0.116 | 0.159 |

### Thermal Testing

Thermal performance of samples was determined in a thermal runaway simulation. FIG. 6 illustrates the apparatus 5000 used for the thermal testing. A thermal management sheet 10 was disposed on hot plate 990 set to 550° C. A 12.7 millimeter (mm) mica plate cell analog 970 was placed on the top surface of the thermal management sheet 10. A thermocouple sensor 980 was inserted into a hole drilled in the mica plate cell analog 970 to dispose the thermocouple sensor 980 on the top surface of the thermal management sheet 10. The thermal management sheet was wrapped in a sheet of aluminum foil such that there was one layer of aluminum foil between the hot plate and the thermal management sheet and one layer of foil between the thermal management sheet and the mica plate.

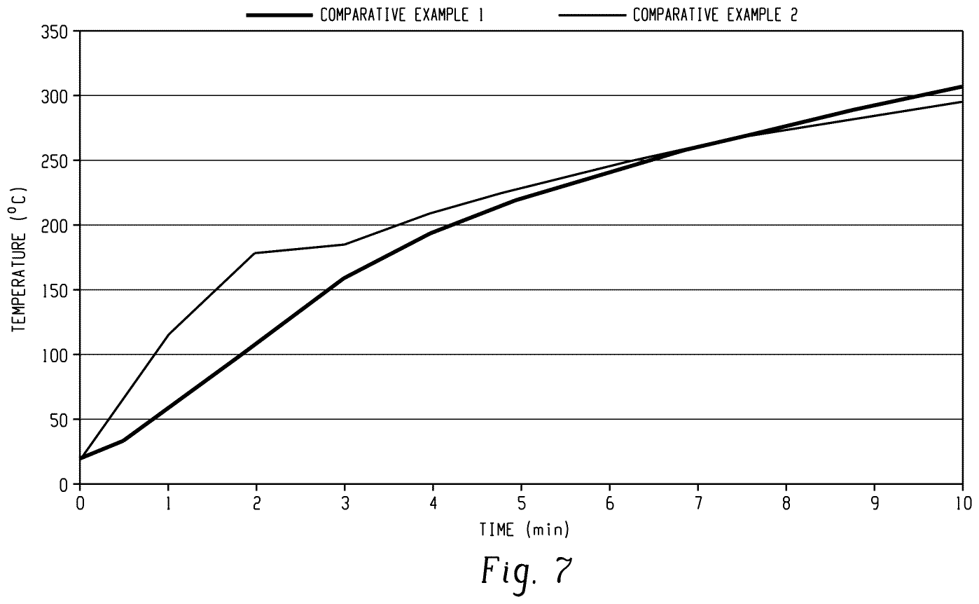

With reference to FIG. 7, Comparative Example 1 does not provide thermal runaway protection and does not have a flammability rating. Comparative Example 2 has a similar Polyol/ISO formulation to Comparative Example 1 but with the addition of 20 parts Exp. Graphite and has an HBF flammability rating. Comparative Examples 1 and 2 do not perform as desired in hot plate testing.

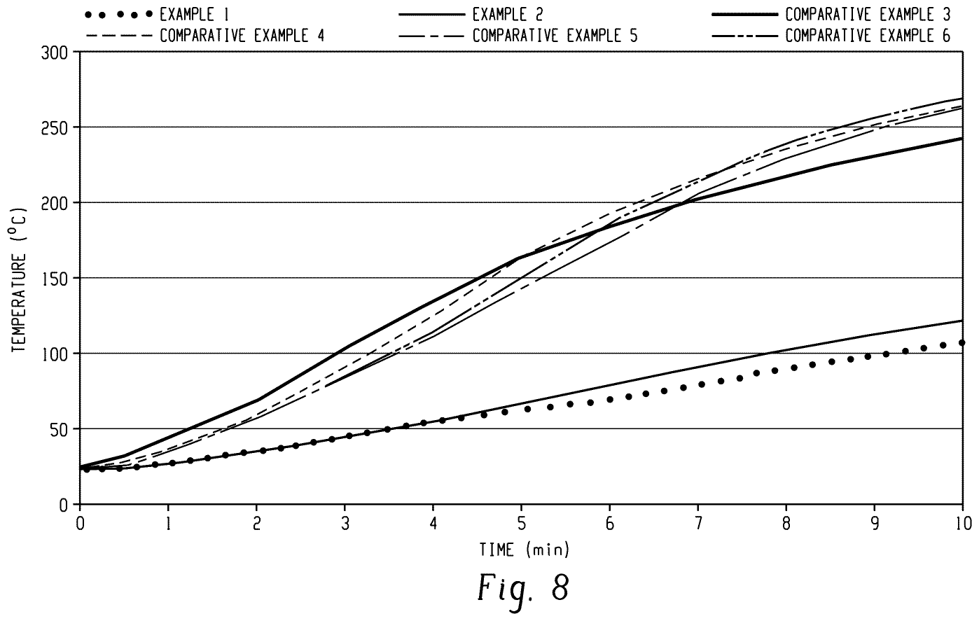

With reference to FIG. 8, Examples 1 and 2 and Comparative Examples 3-6 had similar Polyol/ISO formulation with varied filler compositions. Comparative Example 3 includes ATH, Comparative Example 4 includes zinc borate, Comparative Example 5 includes ATH and zinc borate, Comparative Example 6 includes APB, Example 1 includes sodium borate, and Example 2 includes sodium borate and zinc borate. Examples 1 and 2 perform better than Comparative Examples 3-6 in hot plate testing.

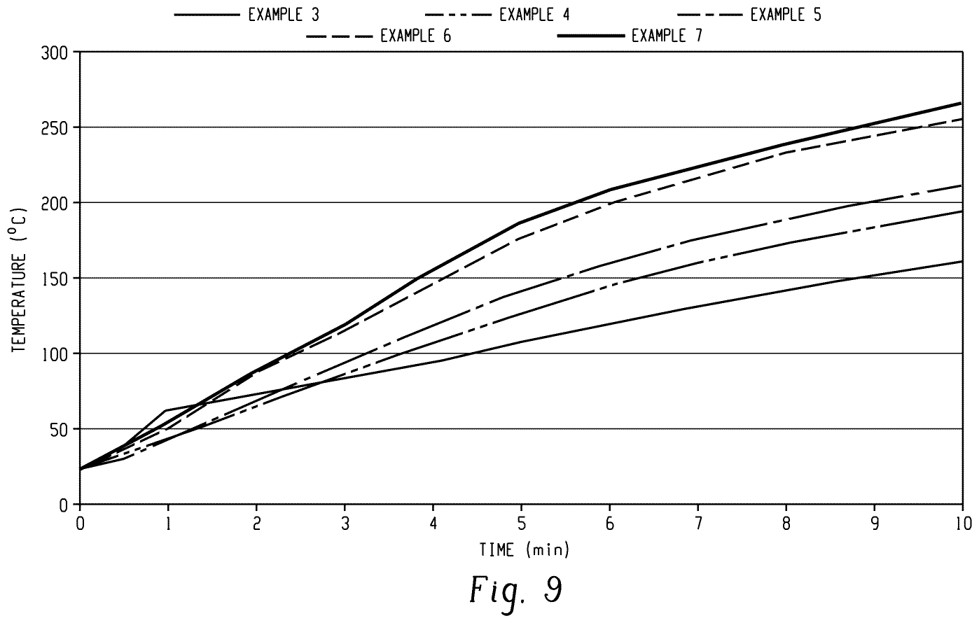

With reference to FIG. 9, Example 3 includes 36 parts sodium borate in Part A, Example 4 includes 30 parts sodium borate in Part A, Example 5 includes 20 parts sodium borate in Part A, Example 6 includes 10 parts sodium borate in Part A, and Example 7 includes 5 parts sodium borate in Part A. Hot plate testing performance improved with increased sodium borate loading.

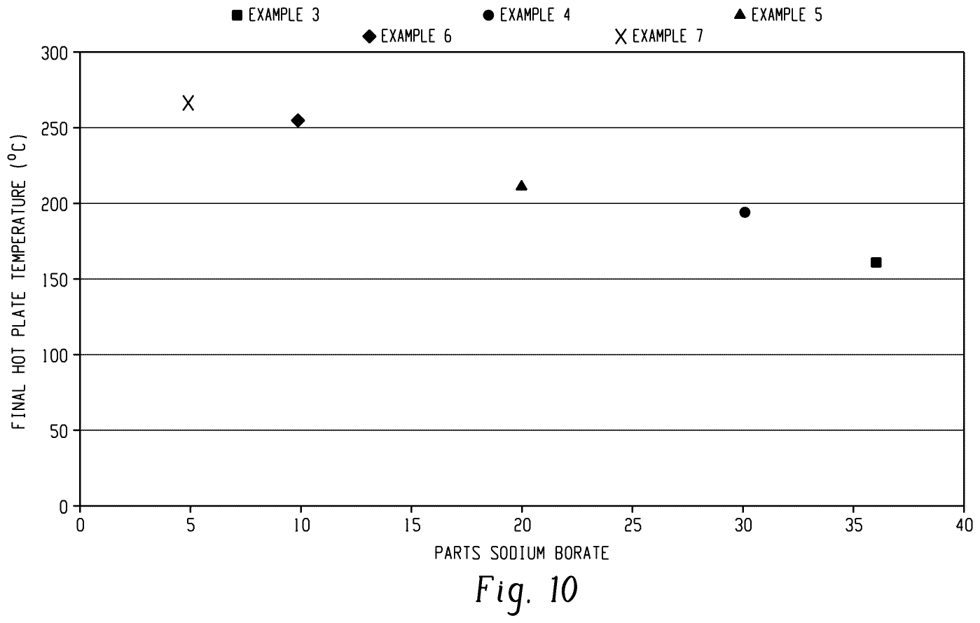

With reference to FIG. 10, Example 3 includes 36 parts sodium borate in Part A, Example 4 includes 30 parts sodium borate in Part A, Example 5 includes 20 parts sodium borate in Part A, Example 6 includes 10 parts sodium borate in Part A, and Example 7 includes 5 parts sodium borate in Part A. Hot plate temperature at 10 minutes decreased with increased sodium borate loading.

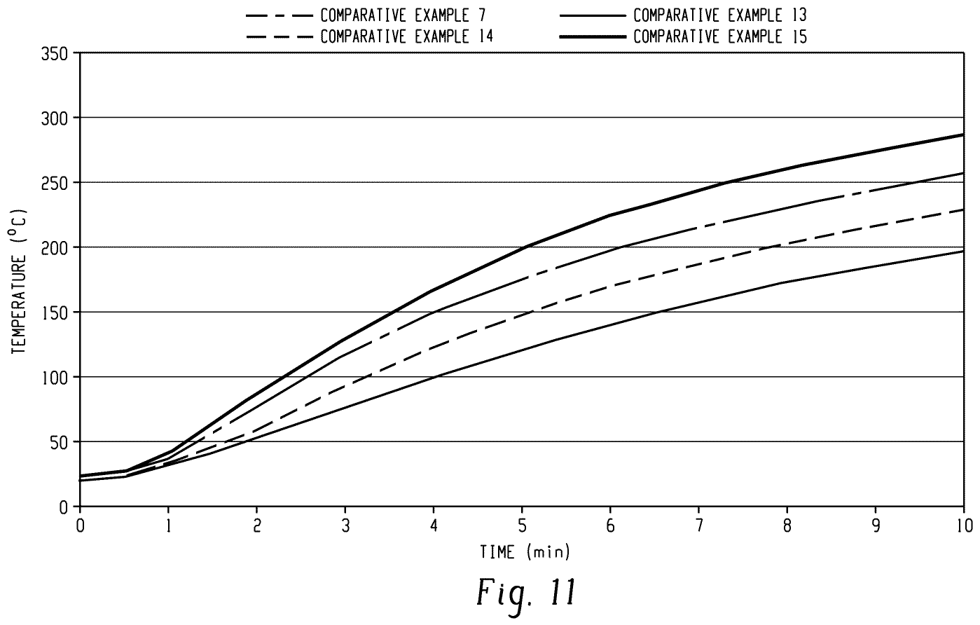

With reference to FIG. 11, Comparative Example 7 includes 36 parts lignin in Part A, Comparative Example 13 includes 18 parts sodium borate and 18 parts lignin in Part A, Comparative Example 14 includes 18 parts zinc borate and 18 parts lignin in Part A, and Comparative Example 15 includes 18 parts MC-APP and 18 parts lignin in Part A. Combining sodium borate, zinc borate, or MC-APP with lignin, a char-forming filler, did not improve hot plate testing performance.

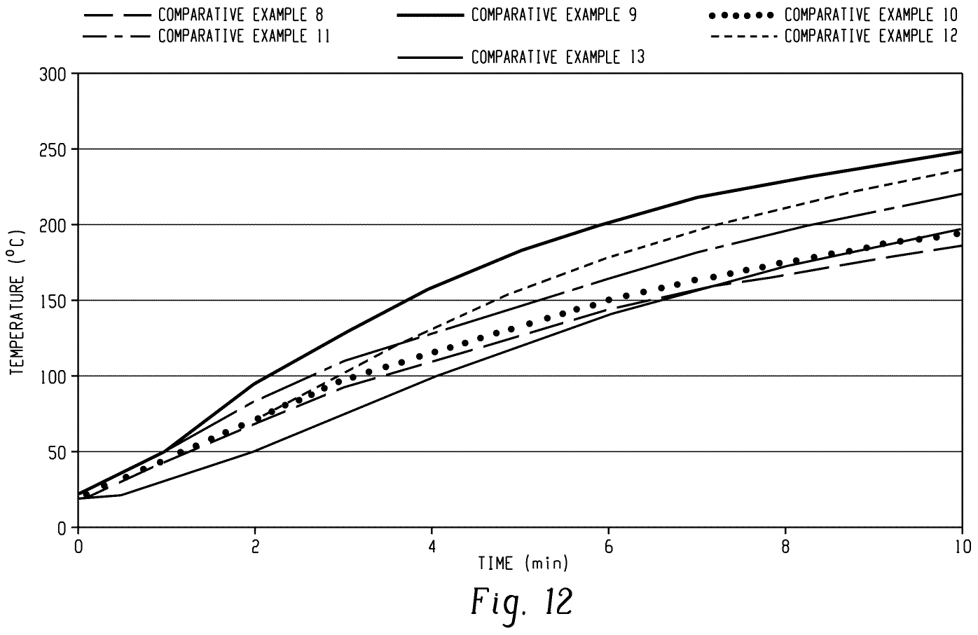

With reference to FIG. 12, Comparative Example 8 includes 26 parts sodium borate and 10 parts sodium silicate in Part A, Comparative Example 9 includes 10 parts sodium borate and 26 parts silica in Part A, Comparative Example 10 includes 18 parts sodium borate and 18 parts expandable graphite in Part A, Comparative Example 11 includes 18 parts sodium borate 18 and parts MC-APP in Part A, Comparative Example 12 includes 18 parts sodium borate and 18 parts SC-APP in Part A, and Comparative Example 13 includes 18 parts sodium borate and 18 parts lignin in Part A.

Compared to Example 6 (see FIGS. 9 and 10), which contained 10 parts sodium borate, the addition of 26 parts ground silica in Comparative Example 9 had no effect. Comparative Example 8, which contained 10 parts of sodium silicate in addition to 26 parts sodium borate performed worse than Example 3 (see FIGS. 9 and 10) with comparable thickness and density. For the same filler loading (36 parts in Part A), having all of the filler as sodium borate is better than having a combination of sodium borate and sodium silicate, expandable graphite, MC-APP, or SC-APP.

Thermal testing results indicate that addition of silicon-containing raw materials may not improve the cohesiveness of a char layer formed, so without being bound by theory, based on the thermal testing results, it is believed that the formation of borosilicate char may not be a relevant mechanism for blocking heat transfer in a thermal management sheet including sodium borate. Nail penetration testing was not performed on Comparative Examples 8 and 9.

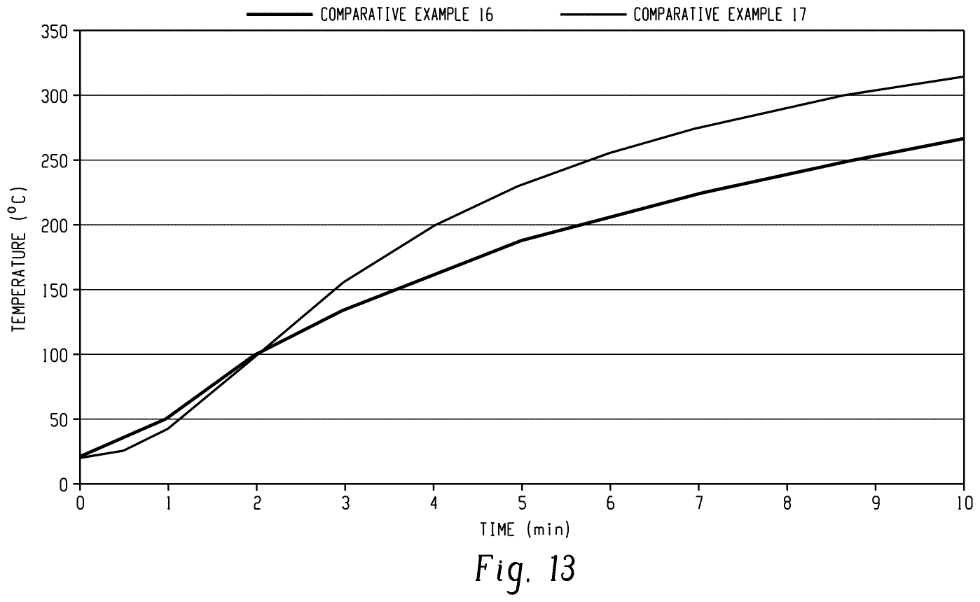

With reference to FIG. 13, Comparative Example 16 includes MC-APP and Comparative Example 17 includes SC-APP. Neither MC-APP nor SC-APP improve hot plate testing performance.

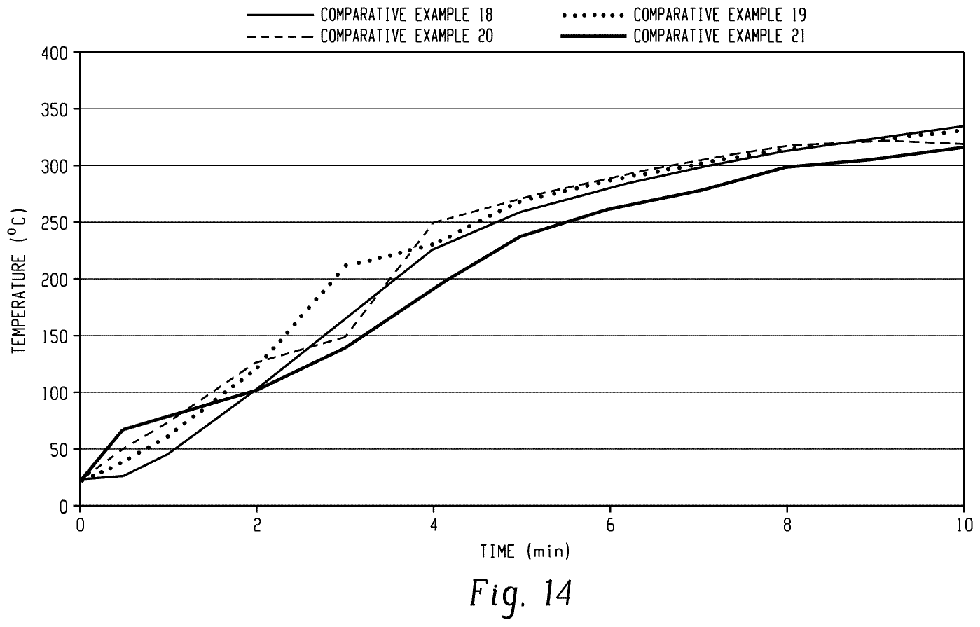

With reference to FIG. 14, Comparative Example 18 includes aerogel, Comparative Example 19 includes calcium sulfate dihydrate, Comparative Example 20 includes calcium oxalate monohydrate (which releases CO and CO₂ upon thermal decomposition), and Comparative Example 21 includes PCM. None of aerogel, calcium sulfate dihydrate, calcium oxalate monohydrate, and PCM improve hot plate testing performance, reaching over 300° C., similar to Comparative Example 1.

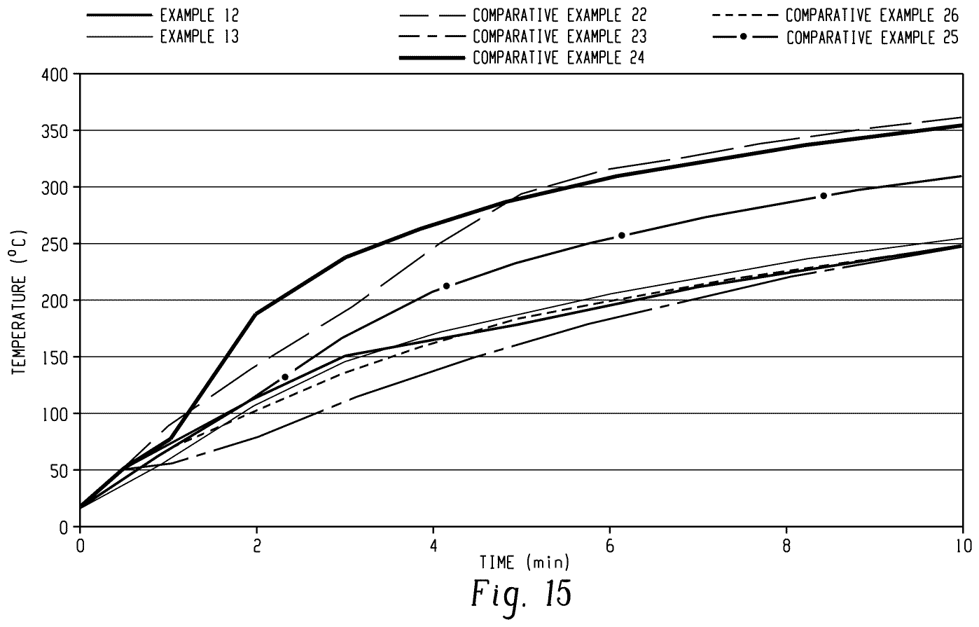

With reference to FIG. 15, Example 13 includes 18 parts of sodium borate and 18 parts of ATH, Example 14 includes 18 parts of sodium borate and 18 parts of zinc borate, Comparative Example 22 includes 36 parts of MC-APP, Comparative Example 23 includes 36 parts of zinc borate, Comparative Example 24 includes 18 parts of zinc borate and 18 parts of ATH, and Comparative Example 25 includes 36 parts of ATH. Comparative Example 26 includes 18 parts sodium borate and 18 parts expandable graphite. Examples 13 and 14 performed relatively well in hot plate testing, compared to Comparative Examples 22, 24, and 25, maintaining a temperature of under 260° C. at 10 minutes. While Comparative Examples 23 and 26 performed relatively well in hot plate testing, in nail penetration testing, Comparative Examples 23 and 26 performed worse than Examples 13 and 14, achieving delays of 27.6 seconds and 31.8 seconds, respectively, compared to 42 seconds and 37.8 seconds for Examples 13 and 14, respectively (see Table 9).

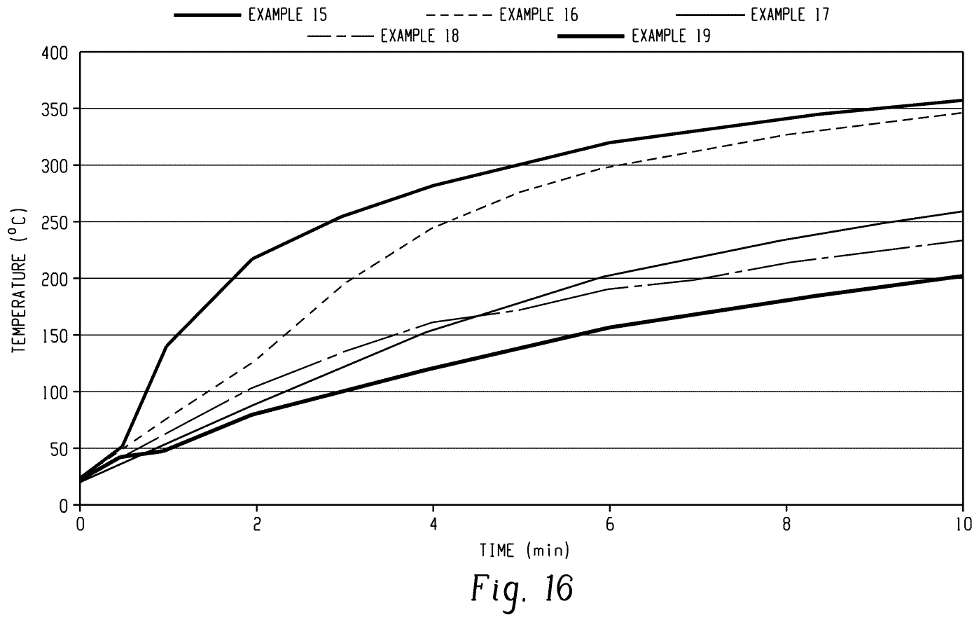

With reference to FIG. 16, Example 15 includes 5 parts sodium borate, Example 16 includes 10 parts sodium borate, Example 17 includes 20 parts sodium borate, Example 18 includes 36 parts sodium borate, and Example 19 includes 40 parts sodium borate. Hot plate testing performance improved with increased sodium borate loading.

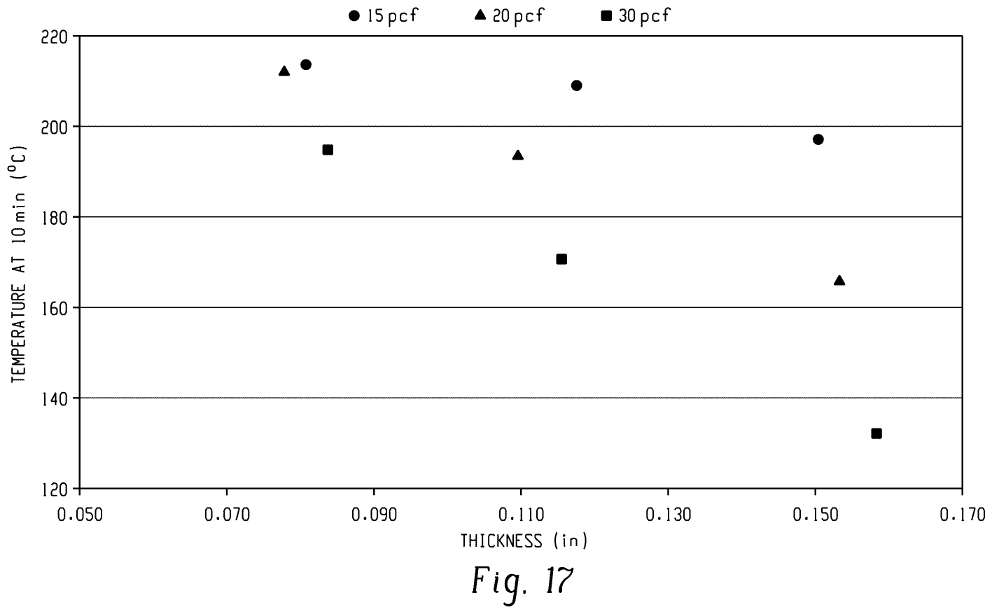

FIG. 17 is a graph of temperature at 10 minutes (° C.) versus thickness (inches) showing results of hot plate testing of Examples 11a-11i. Hot plate testing performance improved with increased density.

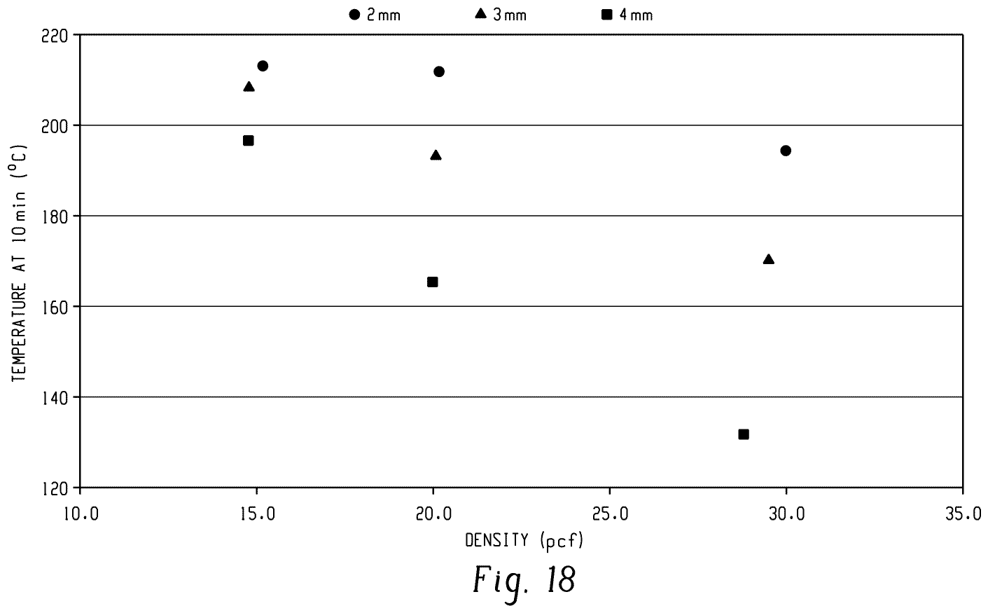

FIG. 18 is a graph of temperature at 10 minutes (° C.) versus density (pcf) showing results of hot plate testing of Examples 11a-11i. Hot plate testing performance improved with increased thickness.

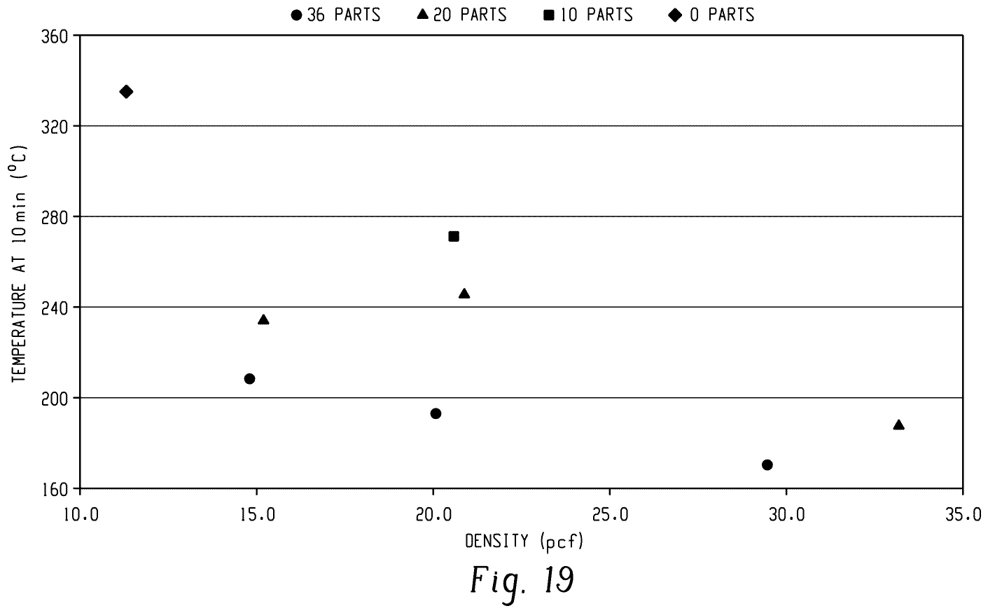

FIG. 19 is a graph of temperature at 10 minutes (° C.) versus density (pcf) showing results of hot plate testing of Comparative Example 1a and Examples 9a, 10a, 10b, 10c, 11a, 11e, and 11h. Hot plate testing performance improved with increased sodium borate loading.

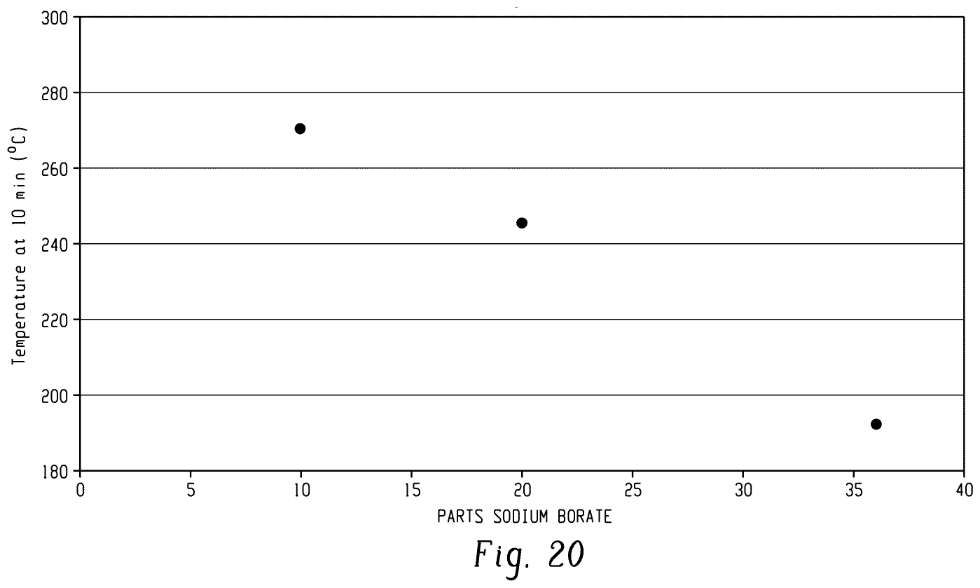

FIG. 20 is a graph of temperature at 10 minutes (° C.) versus parts sodium borate showing results of hot plate testing of Examples 9a, 10b, and 11a. Hot plate testing performance improved with increased sodium borate loading.

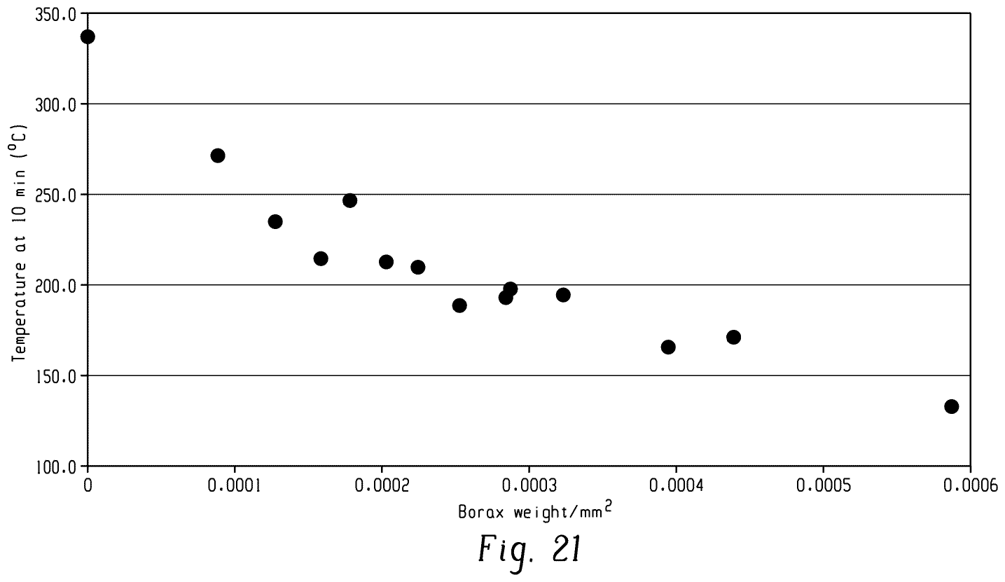

FIG. 21 is a graph of temperature at 10 minutes (° C.) versus sodium borate weight/mm² showing results of hot plate testing of Comparative Example 1a and Examples 9a, 10a-10c, and 11a-11i. Hot plate testing performance improved with increased sodium borate weight/mm².

### Nail Penetration Testing

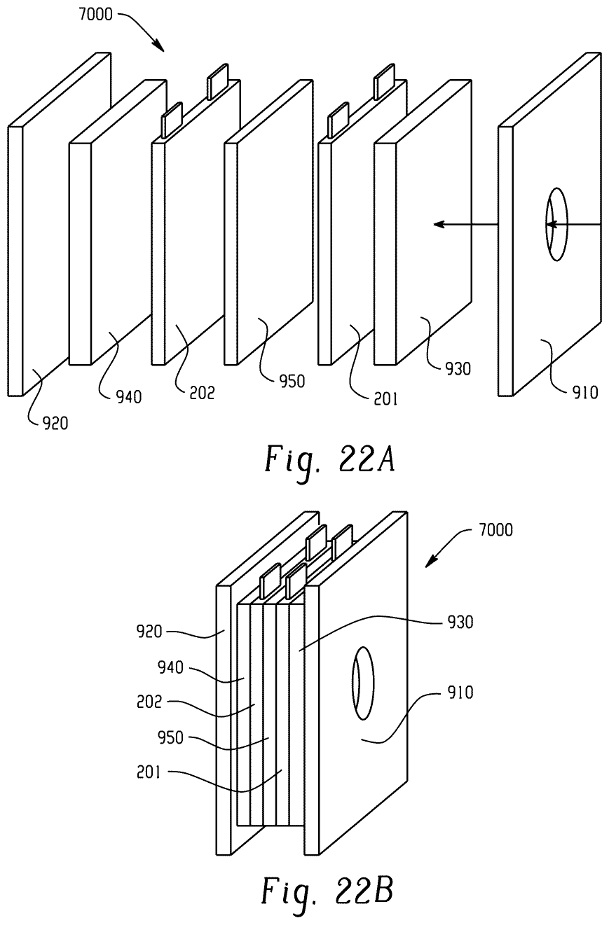

Nail penetration testing was performed. FIG. 22A and FIG. 22B are exploded and non-exploded views, respectively, of a schematic of a first apparatus 7000 for the nail penetration testing, including aluminum end plates 910, 920 (having dimensions of 185 mm×90 mm×15.2 mm), polytetrafluoroethylene insulation film 930, 940 (having dimensions of 185 mm×90 mm×1 mm), pouch cells 201, 202, and the sample 950 tested (for example, the composite thermal management sheet). Characteristics of the cells 201, 202 are provided in Table 8. Cell 201 was punctured by an 8 mm nail inserted at an indentation rate of 10 mm/s to initiate runaway. The cells 201, 202 were electrically isolated. Multiple thermocouples measured the temperature profile. The voltages of cells 201 and 202 were measured. The nail penetration delay was defined as the difference in time between drop of the voltage of cell 201 and that of cell 202.

TABLE 8

| | |
|---|---|
| Cell information | Hi Power Polymer Li-Ion (nickel manganese |
| | cobalt (NMC) Pouch) |
| Capacity | 80 ampere-hour (Ah) |
| | 296 Watt-hour (Wh) |
| Voltage | 3.7 volts (V) (standard); 4.2 V (charging) |
| Energy Density | 250.8 Wh/kilogram (kg) |
| Dimensions | 337 mm × 146 mm × 12 mm |
| (L × W × H) | |
| Weight | 1.18 kg |

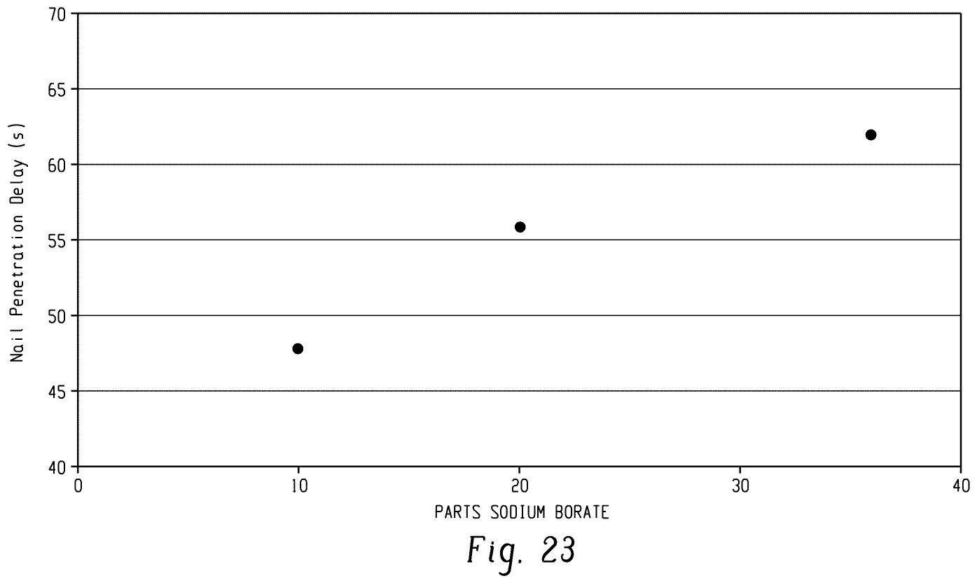

FIG. 23 is graph of nail penetration delay (s) versus parts sodium borate showing results of hot plate testing of Examples 9a, 10b, and 11a. Nail penetration testing performance improved with increased sodium borate loading.

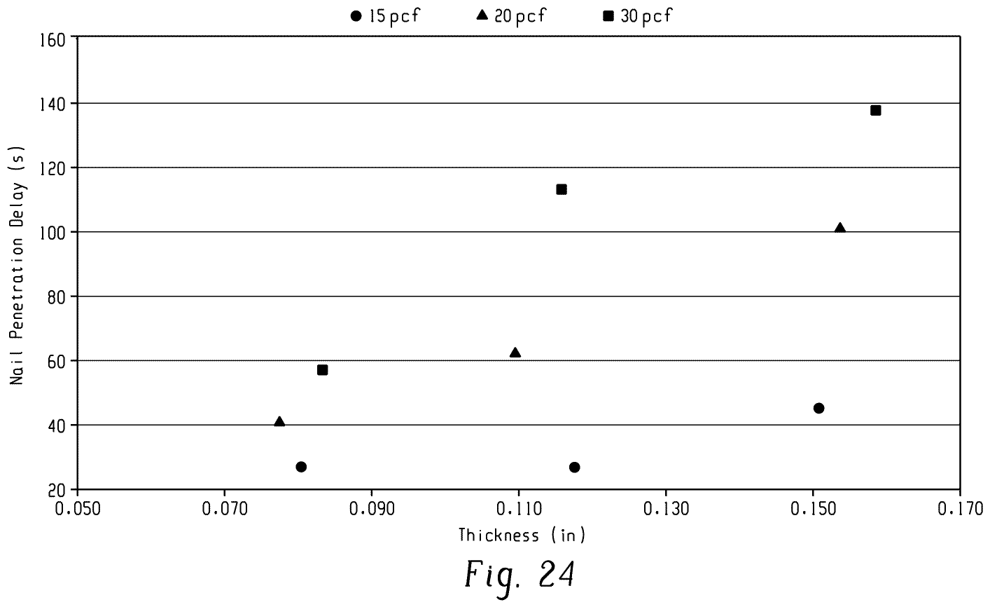

FIG. 24 is graph of nail penetration delay (s) versus thickness showing results of hot plate testing of Examples 11a-11i. Nail penetration testing performance improved with increased density.

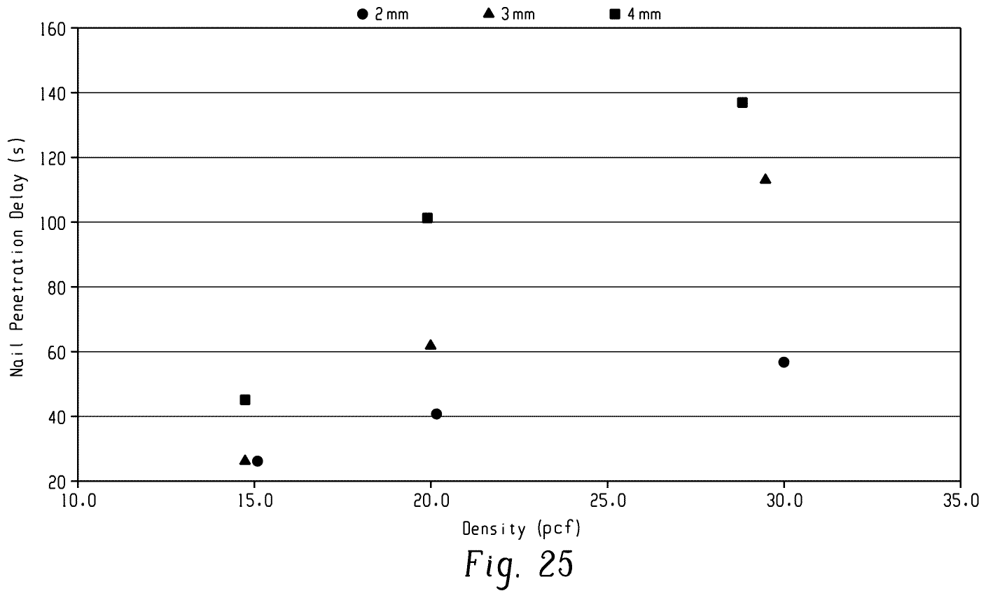

FIG. 25 is graph of nail penetration delay (s) versus density showing results of hot plate testing of Examples 11a-11i. Nail penetration testing performance improved with increased thickness.

TABLE 9

| | | | | Hot Plate | Nail |
|---|---|---|---|---|---|
| | Thickness | Density | | Temperature, | Penetration |
| Sample | (in) | (pcf) | Description | 10 min (° C.) | Delay (s) |
| Example 11 | 0.080 | 20.7 | 36 parts sodium borate | 234.4 | 35.4 |
| Example 13 | 0.081 | 20.2 | 18 parts ATH and | 247.8 | 37.8 |
| | | | 18 parts sodium borate | | |
| Example 14 | 0.083 | 19.2 | 18 parts zinc borate and | 255.6 | 40.8 |
| | | | 18 parts sodium borate | | |
| Comparative Example 22 | 0.087 | 19.5 | 36 parts MC-APP | 362.0 | 34.8 |
| Comparative Example 23 | 0.087 | 20.2 | 36 parts zinc borate | 250.5 | 27.6 |
| Comparative Example 24 | 0.081 | 20.0 | 18 parts zinc borate and | 255.2 | 25.2 |
| | | | 18 parts ATH | | |
| Comparative Example 25 | 0.079 | 19.2 | 36 parts ATH | 309.4 | 21.3 |
| Comparative Example 26 | 0.078 | 18.8 | 18 parts expandable graphite and | 247.8 | 31.8 |
| | | | 18 parts sodium borate | | |

Example 11 includes 36 parts sodium borate in Part A, Example 13 includes 18 parts ATH and 18 parts sodium borate in Part A, and Example 14 includes 18 parts zinc borate and 18 parts sodium borate in Part A. At comparable thickness and density, Example 13 and Example 14 perform slightly better than Example 11 in nail penetration testing, with each of Examples 11, 13, and 14 remaining under 260° C. at 10 min in hot plate testing. Comparative Examples 22, 23, 24, 25, and 26 include 36 parts MC-APP, 36 parts zinc borate, 18 parts zinc borate and 18 parts ATH, 36 parts ATH, and 18 parts expandable graphite and 18 parts sodium borate, respectively. These comparative examples did not perform as well in nail penetration testing as Examples 11, 13, and 14.

Set forth below are non-limiting aspects of this disclosure.

Aspect 1: A method of forming a thermal management sheet for a battery comprising cured polyurethane foam, the method comprising: combining a an active hydrogen-containing component comprising a polyol and an isocyanate component comprising a polyisocyanate to form an uncured polyurethane foam; and curing the uncured polyurethane foam to form the cured polyurethane foam, wherein the uncured polyurethane foam comprises, based on a total weight of the uncured polyurethane foam, 3 to 68 weight percent, or 14 to 36 weight percent, of sodium borate, 0.1 to 7 weight percent, or 2 to 5 weight percent, of surfactant, and 0.001 to 9 weight percent, or 0.04 to 9 weight percent, or 0.04 to 7 weight percent, or 3 to 7 weight percent, of catalyst, wherein the cured polyurethane foam has a density of 12 to 35 pounds per cubic foot (192 to 561 kilograms per cubic meter), or 15 to 20 pounds per cubic foot (240 to 320 kilograms per cubic meter), and wherein the cured polyurethane foam has a thickness of 1 to 30 millimeters, or 1 to 20 millimeters, or 1 to 15 millimeters, or 1 to 10 millimeters, or 1 to 8 millimeters, or 1.5 to 8 millimeters, or 1.5 to 6 millimeters, or 2 to 4 millimeters.

Aspect 2: The method of aspect 1, wherein the uncured polyurethane foam further comprises, based on the total weight of the uncured polyurethane foam, 0 to 33 weight percent, or greater than 0 to 33 wt %, or 7 to 18 weight percent of aluminum trihydrate.

Aspect 3: The method of aspect 1 or 2, wherein the uncured polyurethane foam further comprises, based on the total weight of the uncured polyurethane foam, 0 to 33 weight percent, or greater than 0 to 33 wt %, or 7 to 18 weight percent of zinc borate.

Aspect 4: The method of any of the preceding aspects, wherein the uncured polyurethane foam further comprises, based on the total weight of the uncured polyurethane foam, 0 to 33 weight percent, or greater than 0 to 33 wt %, or 6 to 18 weight percent, of aluminum trihydrate, and 0 to 33 weight percent, or greater than 0 to 33 wt %, or 6 to 18 weight percent, zinc borate.

Aspect 5: The method of any of aspects 1 and 3, wherein the uncured polyurethane foam comprises, based on the total weight of the uncured polyurethane foam, 0 weight percent aluminum trihydrate.

Aspect 6: The method of any of aspects 1 and 2, wherein the uncured polyurethane foam comprises, based on the total weight of the uncured polyurethane foam, 0 weight percent zinc borate.

Aspect 7: The method of aspect 1, wherein the uncured polyurethane foam comprises, based on the total weight of the uncured polyurethane foam, 0 weight percent aluminum trihydrate and 0 weight percent zinc borate.

Aspect 8: The method of any of the preceding aspects, wherein combining the active hydrogen-containing component and the isocyanate component comprises combining, based on a total weight of the composition, 70 to 90 weight percent, or 75 to 89 weight percent, of the active hydrogen-containing component; and 10 to 30 weight percent, or 11 to 25 weight percent, of the isocyanate component.

Aspect 9: The method of any of the preceding aspects, wherein a stoichiometry ratio of isocyanate moieties to hydroxyl groups in the uncured polyurethane foam is 0.85:1 to 1.40:1, or 1.00:1 to 1.20:1.

Aspect 10: The method of any of the preceding aspects, further comprising frothing, physically blowing, chemically blowing, or a combination thereof to form the uncured polyurethane foam.

Aspect 11: A thermal management sheet for a battery formed by the method of any of the preceding aspects.

Aspect 12: The thermal management sheet for a battery of aspect 11, wherein the thermal management sheet consists of the cured polyurethane foam.

Aspect 13: The thermal management sheet of any of aspects 11 and 12, wherein the cured polyurethane foam has a compression force deflection of 0.2 to 125 pounds per square inch, or 1 to 36 pounds per square inch, or 3 to 30 pounds per square inch, each at 25% deflection and determined in accordance with ASTM D3574.

Aspect 14: The thermal management sheet of any of aspects 11 to 13, wherein the cured polyurethane foam has a compression set of 0 to 15%, or 0 to 10%, or 0 to 5%, or greater than 0 to 15%, or greater than 0 to 10%, or greater than 0 to 5%, determined in accordance with ASTM D 3574-95 Test D at 70° C.

Aspect 15: An assembly for a battery, comprising the thermal management sheet of any of aspects 11 to 14 on a surface of an electrochemical cell.

Aspect 16: The assembly for a battery of aspect 15, wherein the assembly comprises at least two electrochemical cells.

Aspect 17: A battery, comprising: the assembly for a battery of aspect 16; and a housing at least partially enclosing the assembly for a battery.

Aspect 18: An uncured polyurethane foam composition comprising: a polyol; a polyisocyanate; 3 to 68 weight percent, or 14 to 36 weight percent, of sodium borate; 0.1 to 7 weight percent, or 2 to 5 weight percent, of surfactant; and 0.001 to 9 weight percent, or 0.04 to 9 weight percent, or 0.04 to 7 weight percent, or 3 to 7 weight percent, of catalyst, wherein weight percentages are based on a total weight of the uncured polyurethane foam composition.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

The terms “a” and “an” do not denote a limitation of quantity, but rather denote the presence of at least one of the referenced items. The term “or” means “and/of” unless clearly indicated otherwise by context. Reference throughout the specification to “an aspect,” “another aspect,” and so forth, means that a particular element (e.g., feature, structure, step, or characteristic) described in connection with the aspect is included in at least an aspect described herein, and may or may not be present in other aspects. In addition, it is to be understood that the described elements can be combined in any suitable manner in the various aspects.

When an element such as a layer, film, region, or substrate is referred to as being “on” another element, it can be directly on the other element or intervening elements can also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

The endpoints of all ranges directed to the same component or property are inclusive of the endpoints, are independently combinable, and include all intermediate points and ranges. For example, ranges of “up to 25 wt %, or 5 to 20 wt %” is inclusive of the endpoints and all intermediate values of the ranges of “5 to 25 wt %,” such as 10 to 23 wt %, etc.). The terms “first,” “second,” and the like, “primary,” “secondary,” and the like, as used herein do not denote any order, quantity, or importance, but rather are used to distinguish one element from another. The term “combination thereof” is open, and means that the list is inclusive of each element individually, as well as combinations of two or more elements of the list, and combinations of at least one element of the list with like elements not named. Also, the term “combination” is inclusive of blends, mixtures, alloys, reaction products, and the like.

Unless defined otherwise, technical and scientific terms used herein have the same meaning as is commonly understood by one of skill in the art to which this disclosure belongs.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

In the drawings, the widths and thicknesses of layers and regions can be exaggerated for clarity of the specification and convenience of explanation. Like reference numerals in the drawings denote like elements.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat can, typically, have rough and/or nonlinear features. Moreover, sharp angles that are illustrated can be rounded. Thus, the regions illustrated in the figures are schematic in nature and their shapes are not intended to illustrate the precise shape of a region and are not intended to limit the scope of the present claims.

While particular aspects have been described, alternatives, modifications, variations, improvements, and substantial equivalents that are or can be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A method of forming a thermal management sheet for a battery comprising cured polyurethane foam, the method comprising:
combining an active hydrogen-containing component comprising a polyol and an isocyanate component comprising a polyisocyanate to form an uncured polyurethane foam; and
curing the uncured polyurethane foam to form the cured polyurethane foam,
wherein the uncured polyurethane foam comprises, based on a total weight of the uncured polyurethane foam,
3 to 68 weight percent of sodium borate,
0.1 to 7 weight percent of surfactant, and
0.001 to 9 weight percent of catalyst,
wherein the cured polyurethane foam has a density of 12 to 35 pounds per cubic foot (192 to 561 kilograms per cubic meter),
wherein the cured polyurethane foam has a thickness of 1 to 30 millimeters.

2. The method of claim 1, wherein the uncured polyurethane foam further comprises, based on the total weight of the uncured polyurethane foam, 0 to 33 weight percent of aluminum trihydrate.

3. The method of claim 1, wherein the uncured polyurethane foam further comprises, based on the total weight of the uncured polyurethane foam, 0 to 33 weight percent of zinc borate.

4. The method of claim 1, wherein the uncured polyurethane foam further comprises, based on the total weight of the uncured polyurethane foam,
0 to 33 weight percent of aluminum trihydrate, and
0 to 33 weight percent zinc borate.

5. The method of claim 1, wherein the uncured polyurethane foam comprises, based on the total weight of the uncured polyurethane foam, 0 weight percent aluminum trihydrate.

6. The method of claim 1, wherein the uncured polyurethane foam comprises, based on the total weight of the uncured polyurethane foam, 0 weight percent zinc borate.

7. The method of claim 1, wherein the uncured polyurethane foam comprises, based on the total weight of the uncured polyurethane foam, 0 weight percent aluminum trihydrate and 0 weight percent zinc borate.

8. The method of claim 1, wherein combining the active hydrogen-containing component and the isocyanate component comprises combining, based on a total weight of the composition,
70 to 90 weight percent of the active hydrogen-containing component; and
10 to 30 weight percent of the isocyanate component.

9. The method of claim 1, wherein a stoichiometry ratio of isocyanate moieties to hydroxyl groups in the uncured polyurethane foam is 0.85:1 to 1.40:1.

10. The method of claim 1, further comprising frothing, physically blowing, chemically blowing, or a combination thereof to form the uncured polyurethane foam.

11. A thermal management sheet for a battery formed by the method of claim 1.

12. The thermal management sheet for a battery of claim 11, wherein the thermal management sheet consists of the cured polyurethane foam.

13. The thermal management sheet of claim 11, wherein the cured polyurethane foam has a compression force deflection of 0.2 to 125 pounds per square inch, at 25% deflection and determined in accordance with ASTM D3574.

14. The thermal management sheet of claim 11, wherein the cured polyurethane foam has a compression set of 0 to 15%, determined in accordance with ASTM D 3574-95 Test D at 70° C.

15. An assembly for a battery, comprising:
the thermal management sheet of claim 11 on a surface of an electrochemical cell.

16. The assembly for a battery of claim 15, wherein the assembly comprises at least two electrochemical cells.

17. A battery, comprising:
the assembly for a battery of claim 16; and
a housing at least partially enclosing the assembly for a battery.

18. An uncured polyurethane foam composition comprising:
a polyol;
a polyisocyanate;
3 to 68 weight percent of sodium borate;
0.1 to 7 weight percent of surfactant; and
0.001 to 9 weight percent of catalyst, wherein
weight percentages are based on a total weight of the uncured polyurethane foam composition.
